(19) United States
(12) Patent Application Publication
(10) Pub. No.: US 2026/0330343 A1
(43) Pub. Date: Oct. 22, 2026

(54) SYSTEM

(71) Applicant: SoftBank Group Corp., Tokyo (JP)

(72) Inventor: Daisuke OGAWA, Tokyo (JP)

(73) Assignee: SoftBank Group Corp., Tokyo (JP)

(21) Appl. No.: 19/650,362

(22) Filed: Apr. 17, 2026

(30) Foreign Application Priority Data
Apr. 21, 2025 (JP) 2025-070027

(51) Int. Cl. G06Q 10/06; G06Q 10/10

(52) U.S. Cl. CPC G06Q 10/06; G06Q 10/10

(57) ABSTRACT

The present invention relates to a system that analyzes a personnel database using generative AI, automatically groups employees who were enrolled together in the same department or project in the past, identifies a managerial employee from within the group as a leader, automatically distributes notifications of alumni events, participation requests, instructions for organizing to the leader, guidance on subsidies for communication expenses, and guidance on using an online meeting system through an internal SNS, e-mail, or the like, and collects and analyzes feedback from participants after the events end to reflect the feedback in subsequent events and company-wide communication measures, thereby realizing the rebuilding of bonds among employees, the strengthening of cross-departmental cooperative relations, and the improvement of engagement and productivity.

### CROSS-REFERENCE TO RELATED APPLICATION

The present application claims priority to and incorporates by reference the entire contents of Japanese Patent Application No. 2025-070027 filed in Japan on Apr. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is a complex problem in which, due to repeated personnel changes such as employee transfers, department changes, promotions, and retirements in a corporate organization, human relations among employees who once collaborated in the same department become diluted, and networks built in the past are severed, thereby reducing opportunities for cross-departmental information sharing, support, and advice, and making internal cooperation difficult; moreover, for managerial employees, it becomes difficult to cooperate with past subordinates and colleagues, making it difficult to obtain sufficient support and cooperation when promoting new projects or solving problems; furthermore, for current team members, a lack of information sharing between departments and a stagnation of idea creation from diverse perspectives make it difficult for innovation to occur; and for the company as a whole, barriers between employees arise every time there is a transfer or department change, reducing company-wide unity and communication, and leading to a lack of inter-departmental synergy and a decrease in employee satisfaction and motivation, and the point is to solve these problems by automatically grouping employees who worked in the same department in the past, creating opportunities for re-exchange by utilizing a system of communication expenses provided by the company, an online meeting system, and the like, and rebuilding bonds among employees and improving company-wide cooperative relations, engagement, productivity, and satisfaction through automatic and efficient operation using generative AI.

### SUMMARY OF THE INVENTION

As a means for solving the problem, a system comprising a personnel data management unit, a group generation unit, and a communication promotion unit is configured, in which, first, the personnel data management unit stores personnel information such as employee names, affiliated departments, department assignment periods, job titles, and contact information as a database; next, the group generation unit analyzes the information stored in the personnel data management unit using generative AI, automatically extracts employees who were enrolled together in a specific department during a specific period, groups the corresponding employees, identifies a managerial employee from within the group, and sets the managerial employee as a leader; and furthermore, the communication promotion unit automatically transmits, using generative AI, notifications of alumni events, participation requests, instructions for organizing the events to the leader, guidance on subsidies for communication expenses provided by the company, and guidance on using an online meeting system to the grouped employees and the leader using communication means such as an internal SNS or e-mail, and further collects feedback from participants after the events end to reflect the feedback in subsequent events, thereby serving as a means to efficiently and continuously promote re-exchange among employees who worked in the same department in the past, and to realize the creation of cross-departmental cooperative relations and new synergies, and the improvement of employee satisfaction and engagement.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

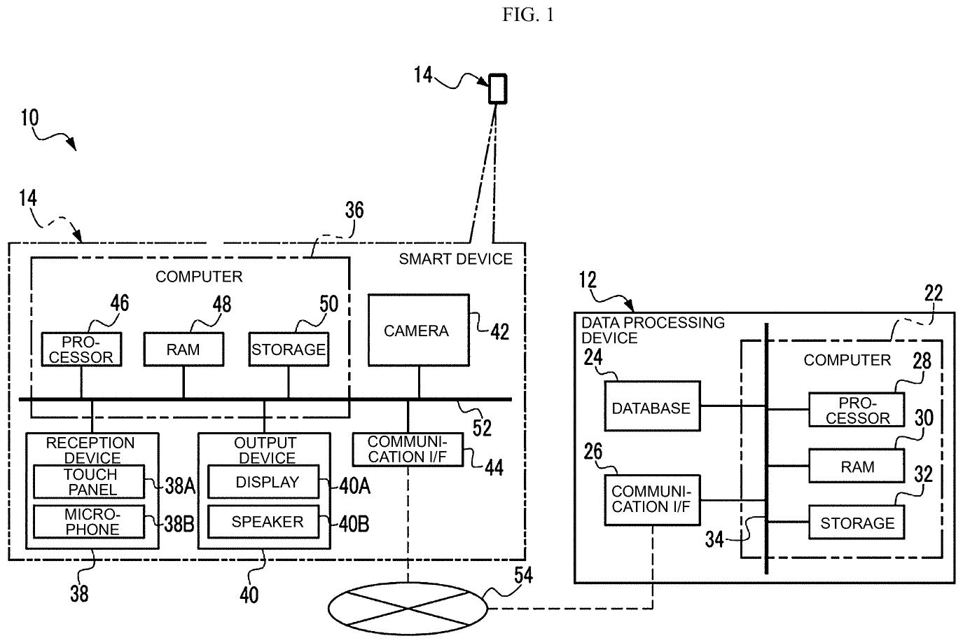

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

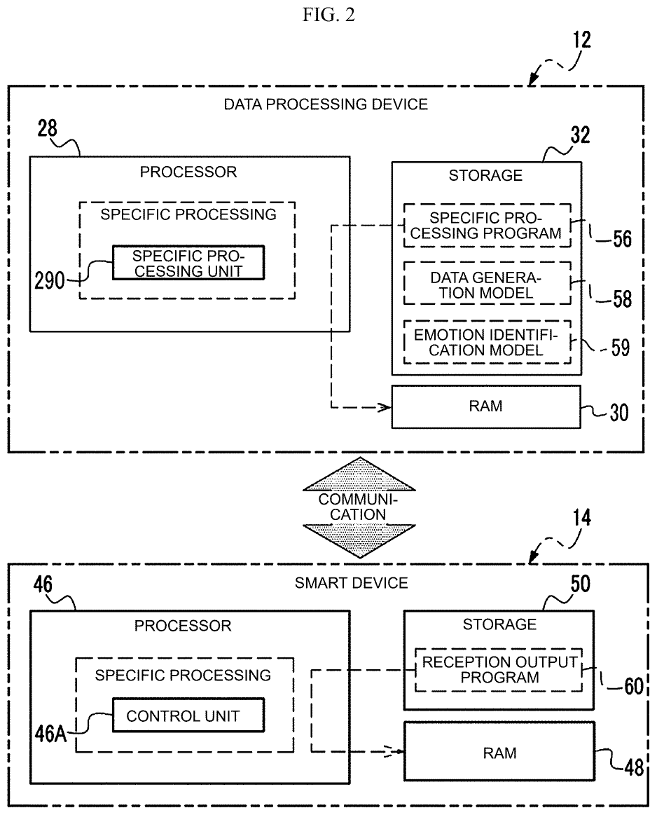

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a configuration in which a server and a terminal are connected via a network is basic, a personnel data management unit, a group generation unit, and a communication promotion unit are provided on the server side, and a user interface unit is provided on the terminal side. Hereinafter, the configuration, function, processing flow, method of utilizing generative AI, specific usage example, and role sharing between the server and the terminal of each unit will be described extremely in detail and comprehensively. Specifically, the present system adopts a distributed computing architecture. The present server includes a parallel processing cluster composed of a plurality of computing nodes. The present server includes a dedicated computing accelerator that executes a large language model and a graph neural network. The present terminal functions as a mobile communication terminal or a personal computer. The present network utilizes a low-latency and broadband encrypted communication protocol. The present personnel data management unit integrally manages a distributed relational database and an unstructured data store. The present group generation unit executes a similarity calculation on a multidimensional vector space. The present communication promotion unit dynamically synthesizes text data using a natural language generation algorithm. The present user interface unit speeds up screen drawing using asynchronous communication. The present system uses a serialized binary format in data transfer between the respective units. The present system applies a zero-copy technology that minimizes data copying on a memory. The present system deploys each unit as an independent container based on a microservice architecture. The present system dynamically scales resources of each unit according to a load using a container orchestration tool. The present system includes a failover mechanism that automatically takes over processing to an alternative node when a failure occurs. The present system continuously collects telemetry data for monitoring an operating status of the entire system. The present system autonomously identifies a bottleneck based on the collected data. The present system optimizes allocation of hardware resources. With this configuration, the present system realizes real-time processing of an enormous amount of personnel data. The present system completely eliminates conventional manual data matching processing. The present system optimizes consumption of computing resources. The present system dramatically reduces data transfer overhead. The present system is applied to specific use cases of optimizing human resource allocation and activating internal communication in a large-scale organization. The present system exhibits a technical effect of improving a response speed of the entire system. The present system exhibits a technical effect of simultaneously ensuring scalability and availability.

First, the personnel data management unit is realized on the server, and centrally stores and manages, as a database, a wide variety of personnel-related information such as employee names, employee numbers, affiliated departments, department assignment start dates and end dates, job titles, contact information, transfer histories, retirement histories, project participation histories, internal award histories, evaluation histories, skill information, qualification information, past alumni event participation histories, exchange histories on an internal SNS, and internal questionnaire results. For example, when employee A was enrolled in the development department from April 2017 to March 2019, then enrolled in the sales department from April 2019 to March 2022, and transferred to the human resources department from April 2022, all of this information is recorded in chronological order. Furthermore, when employee A participated in a new business project in 2018, received an internal award in 2019, and acquired a qualification in 2020, this information is also linked. The personnel data management unit can manage this information in various formats such as CSV, a database management system, and cloud storage, and can also perform API linkage with an external personnel system, attendance management system, evaluation system, internal SNS, mail server, and the like. Specifically, the present personnel data management unit executes a data pipeline for extracting data from heterogeneous data sources. The present personnel data management unit normalizes the extracted data. The present personnel data management unit converts the normalized data into a multidimensional tensor format. The present tensor includes a feature vector expressing attribute information of the employee. The present feature vector is configured as, for example, a 512-dimensional floating-point number array. Each element of the present feature vector has a value obtained by encoding categorical data of the affiliated department or continuous value data of the enrollment period. The present personnel data management unit converts evaluation histories and skill information in a text format into embedding vectors using a natural language processing model. The present personnel data management unit stores these vector data in a vector database. The present personnel data management unit reads frequently accessed data at high speed using an in-memory cache. The present personnel data management unit uses a stateless communication protocol in API communication with an external system. The present personnel data management unit applies a differential update algorithm during data synchronization. The present algorithm minimizes consumption of a network bandwidth. The present personnel data management unit calculates a hash value of data to detect falsification. The present personnel data management unit saves history data of the employee together with a time stamp using a time-series database. The present personnel data management unit constructs a data index in a B-tree structure. By this process, the present personnel data management unit ensures data consistency. The present personnel data management unit eliminates a data reading delay in subsequent AI processing. The present personnel data management unit dramatically improves a search speed of a large-scale employee database. The present configuration is extremely effective in a use case of integrated management of human resource data on a scale of tens of thousands of people in a global company. The present configuration brings about a technical effect of eliminating data silos. The present configuration exhibits a technical effect of maximizing utilization efficiency of a storage capacity.

Next, the group generation unit is realized on the server, and analyzes the enormous amount of personnel information stored in the personnel data management unit using generative AI. The generative AI operates by combining natural language processing, time-series analysis, clustering, pattern recognition, a recommendation algorithm, and the like. For example, when an administrator instructs “group employees who were enrolled in the development department from 2018 to 2020”, the AI extracts the employees who were enrolled during the corresponding period, and optimizes the group by also taking into consideration overlaps in enrollment periods, project participation histories, job title histories, and the like. Furthermore, it can also respond to complex conditions and ambiguous instructions, such as “employees who were enrolled in the same department with an overlap of one year or more”, “employees who have experience collaborating multiple times in the same project”, and “employees who have interacted with each other at alumni events in the past”. For example, the AI flexibly responds to a condition such as “extract only those who worked in the sales department from 2019 to 2021 and are currently transferred to other departments”. Specifically, the present group generation unit receives a feature vector group of employees extracted from the present personnel data management unit as input data. The present input data is, for example, a two-dimensional tensor having a shape of the number of employees rows and 512 columns. The present input data further includes an instruction vector obtained by tokenizing an instruction text of the administrator. The present instruction vector is, for example, a 768-dimensional embedding representation. The present group generation unit executes a transformer-based large language model and a graph neural network. The present model calculates cross-attention between the input feature vector group and the instruction vector. The present model dynamically generates an adjacency matrix representing relationships among the employees. The present model updates a node representation of each employee through a graph convolution operation. The present model generates, as output data, a score matrix indicating a probability that each employee belongs to a specific group. The present output data is, for example, a two-dimensional tensor having a shape of the number of employees rows and the number of group candidates columns. Each element of the present output data takes a continuous value between 0 and 1. The present group generation unit executes a threshold determination process on the present score matrix. The present group generation unit clusters employees whose scores exceed a predetermined threshold as the same group. The present group generation unit calculates, for example, a high score for an employee who satisfies a condition of being enrolled in the same department during a specific period. The present group generation unit lowers a score of an employee who does not satisfy the condition using a penalty function. The present group generation unit optimizes weight parameters of the present model in advance using supervised learning and reinforcement learning. The present learning process applies a gradient descent method so as to minimize a cross-entropy error function. By this process, the present group generation unit instantaneously analyzes a combination of multidimensional conditions exceeding human cognitive limits. The present group generation unit reduces conventional manual list creation time to zero. The present group generation unit realizes optimal human resource matching. The present function is applied to use cases of selecting members for a cross-company project and forming a community of specific skill holders. The present function exhibits a technical effect of reducing a useless search space of computer resources and improving processing efficiency.

The group generation unit also includes an automatic identification function for a managerial employee. For example, when a plurality of managerial employees such as a “department manager”, a “section manager”, and a “leader” exist in a group, the AI comprehensively evaluates job title hierarchies, enrollment periods, past leader experiences, project leader histories, internal award histories, and the like, and automatically selects an optimal leader. When no managerial employee exists, the AI can also automatically recommend an employee having the longest enrollment period, a person with project leader experience, an employee having a high transmission frequency on the internal SNS, or the like as a leader candidate. For example, if there are five “persons enrolled in the development department from 2018 to 2020” in the group, of which two are section managers at that time, one is a current department manager, and two are general employees, the AI sets the current department manager as the leader, but if the department manager is busy and cannot participate, the AI sets a section manager or a general employee having a long enrollment period as an alternative leader. Specifically, the present group generation unit receives an attribute vector of each employee belonging to the group as input data. The present attribute vector is, for example, a 128-dimensional numerical array including digitized data of a job title hierarchy, a continuous value of an enrollment period, and a leader experience flag. The present group generation unit further receives a context vector indicating a purpose of the group as input data. The present group generation unit executes an evaluation model using a multilayer perceptron. The present evaluation model combines the attribute vector of each employee and the context vector to perform a non-linear transformation. The present evaluation model generates a leader aptitude score of each employee as output data. The present leader aptitude score is a floating-point number taking a range from 0.0 to 1.0. The present evaluation model further generates a categorical label indicating a reason for selection as output data. The present categorical label is, for example, an integer value indicating that the selection is based on past project achievements. The present group generation unit identifies an employee having the highest score among the present output data. The present group generation unit registers the identified employee as a leader in the database. The present group generation unit assigns a leader flag to a data record of the identified employee. The present group generation unit determines a case where the employee with the highest score is in a non-participable state. When detecting the non-participable state, the present group generation unit automatically resets an employee having the next highest score as an alternative leader. The present evaluation model is pre-trained using leader attribute data of past successful groups as correct labels. The present learning process updates weights of a network using a backpropagation method. By this process, the present group generation unit eliminates personal judgments. The present group generation unit realizes objective and data-driven leader selection. The present function is applied to use cases of selecting an organizer for a large-scale internal event and appointing a person in charge of a new task force. The present function brings about a technical effect of speeding up a decision-making process of organizational management. The present function exhibits a technical effect of reducing a project delay risk due to inappropriate leader selection.

The group generation unit is also capable of grouping across a plurality of departments or projects. For example, the AI automatically executes grouping combining a plurality of conditions, such as “employees who have experience of being enrolled in both the development department and the sales department from 2017 to 2019”, “all employees involved in a new business project in 2018”, and “employees who transferred across a plurality of departments from 2020 to 2022”. Furthermore, the AI also refers to past collaboration histories among employees, exchange histories on the internal SNS, past alumni event participation histories, internal questionnaire results, and the like, and proposes a group configuration that maximizes group affinity and exchange effects. For example, optimization is also possible, such as preferentially grouping team members who obtained high evaluations in the same project in the past, or organizing a group centering on employees who had a high participation rate in past alumni events. Specifically, the present group generation unit receives a transfer history sequence of an employee as input data. The present transfer history sequence is an array of department IDs arranged in chronological order. The present group generation unit further receives graph structure data of project participation histories as input data. The present graph structure data is a data structure having employees as nodes and collaboration track records as edges. The present group generation unit encodes the present transfer history sequence into a fixed-length vector using a recurrent neural network. The present group generation unit aggregates neighborhood information of each employee from the present graph structure data using a graph attention network. The present group generation unit combines these vector representations to generate an integrated feature amount. The present group generation unit calculates an affinity score of the group using the present integrated feature amount. The present group generation unit generates, as output data, a numerical value of the affinity score and a list of recommended group configurations. The present recommended list is expressed as a set of arrays of employee IDs. The present group generation unit selects a configuration having the maximum affinity score among the present output data. The present group generation unit assigns a common group ID to the employees included in the selected configuration. The present group generation unit searches for an optimal solution from among an enormous number of combinations using a genetic algorithm. The present search process utilizes the affinity score as a fitness function. By this process, the present group generation unit extracts a hidden human resource network that cannot be discovered by a simple rule base. The present group generation unit breaks down silos between departments. The present function is applied to use cases of organizing a cross-industry exchange meeting aimed at creating innovation and forming a company-wide cross-sectional problem-solving team. The present function brings about a technical effect of improving knowledge sharing efficiency of the entire organization. The present function exhibits a technical effect of significantly shortening calculation time for an optimization problem satisfying complex constraint conditions.

The communication promotion unit is realized on the server, and automatically transmits, using generative AI, notifications of alumni events, participation requests, instructions for organizing the events to the leader, guidance on subsidies for communication expenses provided by the company, guidance on using an online meeting system, and the like to the grouped employees and the leader using various communication means such as an internal SNS, e-mail, a chat tool, an internal portal site, calendar linkage, smartphone notifications, web push notifications, and voice assistant linkage. For example, the AI automatically generates a notification text such as “To everyone in the 2018 development department alumni group, an alumni event will be held using an online meeting tool on [Month] [Day]. Those who wish to participate, please register from the following link”, and transmits it to the terminal of each member. To the leader, an individual instruction such as “You are requested to organize the event as a group leader. The AI will support confirmation of attendance of participants, adjustment of agenda items, and the like” is also transmitted. The notification text can also be personalized and automatically generated by the AI according to employee attributes, past participation histories, and working styles (remote work, on a business trip, etc.). Specifically, the present communication promotion unit receives attribute data of group members as input data. The present attribute data includes categorical variables indicating age groups, job titles, and working styles. The present communication promotion unit further receives metadata of the event as input data. The present metadata is structured data indicating a holding date and time and a purpose. The present communication promotion unit further receives a reaction history vector to past notifications as input data. The present reaction history vector is a numerical array indicating an open rate and a click rate. The present communication promotion unit executes a large language model to analyze these input data. The present model generates personalized notification text data as output data. The present notification text data is a character string in natural language. The present model further generates an optimal recommended transmission time for each member as output data. The present recommended transmission time is data in a time stamp format. The present communication promotion unit incorporates the generated text data into a payload of each communication protocol. The present communication promotion unit adds the payload to a transmission queue at the designated recommended transmission time. The present communication promotion unit asynchronously delivers a message via a message broker. By this process, the present communication promotion unit eliminates uniform simultaneous transmission. The present communication promotion unit realizes optimal information transmission tailored to the situation of each employee. The present function is applied to use cases of notifying internal events and reliably transmitting emergency contacts under a remote work environment. The present function brings about a technical effect of statistically significantly improving the open rate of notifications and the event participation rate. The present function exhibits a technical effect of dispersing peaks of network traffic and leveling a communication load.

The communication promotion unit also automates guidance on a subsidy system for communication expenses provided by the company when holding an event. For example, the generative AI automatically creates guidance such as “This event is eligible for the company's communication expense subsidy system. Food and beverage expenses, venue expenses, and online meeting system usage fees will be borne by the company. Please check the internal portal for details”, and transmits it to the participants. Furthermore, as guidance on using the online meeting system, the AI can also automatically generate and guide specific procedures and FAQs, such as “An online meeting will be held from [Time] on [Month] [Day] at the following link. Account registration is required in advance”. The AI can also automatically adjust the difficulty level and content of the guidance text according to the IT literacy of the participants and their past online meeting participation experiences. Specifically, the present communication promotion unit receives a rule text extracted from a company regulation database as input data. The present rule text is character string data describing application conditions and an upper limit amount of subsidies. The present communication promotion unit further receives an IT literacy score of a participant as input data. The present IT literacy score is a normalized numerical value from 0 to 100 calculated from past system usage histories. The present communication promotion unit executes a natural language generation model to process these input data. The present model generates a guidance text whose difficulty level is adjusted as output data. The present guidance text is a character string in which the frequency of technical terms and the length of sentences are controlled. The present model further generates structured data of FAQs as output data. The present structured data is a JSON array storing pairs of questions and answers. The present communication promotion unit dynamically embeds the present output data into an HTML template for display of the user interface unit. The present communication promotion unit automatically adds a link to an illustrated image for a participant having a low IT literacy score. The present communication promotion unit provides a link to detailed API specifications for a participant having a high IT literacy score. The present model optimizes a text generation policy by receiving user comprehension feedback as a reward using reinforcement learning. By this process, the present communication promotion unit eliminates information asymmetry. The present communication promotion unit dramatically reduces the number of inquiries to a help desk. The present function is applied to use cases of thoroughly disseminating complex internal systems and supporting the introduction of new IT tools. The present function brings about a technical effect of improving a user's self-resolution rate. The present function exhibits a technical effect of releasing human resources required for support operations and reducing operation costs of the entire system.

Before holding the event, the AI manages attendance statuses of participants in real time, and automatically delivers a progress report to the leader and administrators. For example, progress management such as “Currently, 7 out of 10 people have registered for participation, and 3 people are unanswered. A reminder notification will be automatically transmitted to the unanswered people” is possible. On the day of the event, the AI cooperates with the online meeting system to execute automatic generation of a participant list, automatic delivery of a meeting link, entry/exit management of participants, automatic display of agenda items, Q&A response by a chatbot, automatic generation of minutes, automatic saving of recorded video/audio data, and the like. For example, the AI provides progress support such as “Today's agenda is XX. If you have any questions, please enter them in the chat. The AI will automatically answer”. Specifically, the present system receives an attendance status array of participants as input data. The present attendance status array is a two-dimensional array in which an ID and an answer state of each employee are paired. The present system further receives audio stream data of the online meeting as input data. The present audio stream data is a time-series acoustic feature amount acquired at a sampling rate of 16 kHz. The present system monitors the attendance status using a state transition model. The present system generates a progress report text as output data. The present system executes a voice recognition neural network to process the audio stream data. The present network generates, as output data, character string data in which utterance contents are converted into text. The present system temporarily saves the text data, which is the present output data, on a memory as a fragment of the minutes. The present system automatically fires a trigger for a reminder process when detecting a status of an unanswered state. The present system classifies an intention of a question text input in the chat using a natural language understanding model. The present system extracts an optimal answer text from a knowledge base based on a classification result, and automatically transmits it to a chat screen. The present system inputs the text data temporarily saved at the end of the meeting into a summarization model to generate final minutes data. The present system saves the generated minutes data in a persistent storage. By this process, the present system realizes complete automation of event management. The present system reduces a burden on a human facilitator to zero. The present function is applied to use cases of an online company-wide assembly on a scale of hundreds of people and a global meeting where multiple languages are spoken. The present function brings about a technical effect of facilitating the progress of a meeting and reducing time costs. The present function exhibits a technical effect of minimizing a delay in real-time processing of audio data and enhancing responsiveness of the system.

After the event ends, the communication promotion unit transmits a feedback request to all participants using generative AI. For example, it automatically generates a questionnaire such as “Please let us know your opinions, such as what you gained by participating in this alumni event, new ideas, and future points for improvement”, and collects answers through the user interface unit of the terminal. The AI automatically analyzes the collected feedback, and automatically delivers quantitative and qualitative analysis results, such as “satisfaction of event participants was high”, “a plurality of ideas for new projects were born”, and “there are many voices desiring face-to-face holding next time”, to the administrators and the leader as a report. The AI can also automatically propose an optimal holding time, holding format, group configuration, agenda candidates, and the like for the next event based on past feedback histories, event participation histories, and employee attribute information. Specifically, the present communication promotion unit receives a feedback text group in natural language collected from the participants as input data. The present feedback text group is a corpus composed of a plurality of character string data. The present communication promotion unit executes a natural language processing pipeline to perform morphological analysis and syntactic analysis on the present corpus. The present communication promotion unit calculates a sentiment polarity score of each text using a sentiment analysis model. The present sentiment polarity score is a floating-point number taking a range from minus 1.0 to plus 1.0. The present communication promotion unit extracts a latent topic distribution from the text group using a topic modeling algorithm. The present communication promotion unit generates, as output data, a list of extracted keywords and an importance score of each topic. The present communication promotion unit further generates recommended parameters for the next event as output data. The present recommended parameters include a time stamp of a holding time and enumerated data indicating a holding format. The present communication promotion unit converts these output data into structured data for dashboard display. The present communication promotion unit transmits the converted data to an administrator terminal through a secure communication path. The present model performs a regression analysis using success indicators of past events as objective variables to improve accuracy of the recommended parameters. By this process, the present communication promotion unit instantaneously quantifies a large amount of free-description questionnaires. The present communication promotion unit provides an objective evaluation index excluding human subjectivity. The present function is applied to use cases of measuring effects of internal training and analyzing customer feedback after a new product presentation. The present function brings about a technical effect of automating a continuous process improvement cycle based on data. The present function exhibits a technical effect of dramatically enhancing calculation efficiency for extracting valuable insights from unstructured data.

On the terminal side, a user interface unit used by employees and managerial employees is realized, and a screen capable of intuitively operating notifications and guidance transmitted from the server, event participation registration, feedback answers, and the like is provided. For example, using a smartphone, a browser of a personal computer, a dedicated application, or the like, confirmation of event details, registration of participation availability, preliminary exchange via chat, participation in an online meeting on the day, questionnaire answering, and the like are possible. The user interface unit can also display guidance texts and FAQs generated by the AI, past event histories, participant lists, and the like in real time. For example, a function allowing an employee to check “what kind of alumni events were held in the past”, “which group one belongs to”, “profiles of event participants”, and the like can also be implemented. Specifically, the present user interface unit is constructed as a single-page application using a front-end framework. The present user interface unit speeds up differential drawing of a screen using a virtual document object model. The present user interface unit establishes a bidirectional communication session using a WebSocket protocol with the server. The present user interface unit receives event data in a JSON format push-delivered from the server as input data. The present event data includes a text of a guidance text and URLs of profile images of participants. The present user interface unit generates an event object based on a user's tap operation or keyboard input as output data. The present user interface unit transmits the present event object to the server using asynchronous communication. The present user interface unit caches frequently accessed data on the client side using a local storage of a browser or an indexed database. The present user interface unit executes a service worker in the background to provide some functions even in an offline state. The present user interface unit adopts a responsive design and dynamically changes a layout according to a screen resolution. By this process, the present user interface unit minimizes an influence of a network delay. The present user interface unit realizes smooth operability equivalent to that of a native application. The present function is applied to use cases of access from a smartphone while moving and use in a place where a communication environment is unstable. The present function brings about a technical effect of reducing the number of requests to the server and reducing a load on a back end. The present function exhibits a technical effect of shortening a user's waiting time and improving usability of the entire system.

Furthermore, the generative AI can provide support in real time even while the event is in progress. For example, during an online meeting, the AI can automatically create minutes, immediately answer questions from participants as a chatbot, and instantly present past collaboration histories and project materials. In addition, the AI can analyze the contents of remarks and chat histories of the participants, and automatically extract and report “themes discussed in this event”, “candidates for future collaboration”, and the like after the event ends. For example, the AI automatically generates a specific proposal such as “Three new business ideas were proposed in this event. We propose holding a workshop based on these ideas next time.” Specifically, the system receives a real-time chat text stream as input data. The system further receives, as input data, character string data obtained by converting the voice of a speaker into text. The system processes these input data in milliseconds using a stream processing engine. The system executes a named entity recognition model to extract technical terms and personal names from the text. The system searches a database for past project materials related to the extracted entities using a vector search engine. The system generates a response text of the chatbot as output data. The system further generates a vector representation of the extracted topic as output data. The topic vector is, for example, a 256-dimensional numerical array. The system immediately renders the response text in a designated area of a chat screen. The system accumulates the topic vector in a time-series database. The system applies a clustering algorithm to a group of topic vectors accumulated after the event ends. The system synthesizes a report text from a centroid vector of a cluster using a natural language generation model. By this process, the system reduces the time required for information retrieval during a meeting to zero. The system significantly reduces the cognitive load on the participants. This function is applied to a use case of a development meeting in which brainstorming sessions and technical discussions frequently occur. This function brings about a technical effect of maximizing the productivity of the meeting. This function exhibits a technical effect of avoiding a disk IO bottleneck by in-memory processing of stream data.

For example, when holding an alumni event for employees who were enrolled in the development department from 2019 to 2020, the AI automatically extracts the corresponding employees, sets a group leader, transmits an event notification to everyone, manages a participation registration status in real time, automatically distributes an online meeting link on the day, automatically transmits a questionnaire after the event ends, and reports an aggregation result to an administrator. For example, even when holding a cross-sectional event for persons having project experience across a plurality of departments, the AI can analyze complex conditions and automatically generate an optimal group configuration and event notification. For example, based on an exchange history on the internal SNS, it is also possible to organize employees who have had little exchange in the past into the same group to promote cross-departmental network construction. Specifically, the system executes a data pipeline integrating a series of processes. The system links a batch processing module and a stream processing module. The system receives a search query parameter set by the administrator as input data. The search query parameter is structured data including a period and a department ID. The system dynamically generates and executes an SQL query for a relational database. The system generates a list of employee IDs matching the conditions as output data. The system passes the list to a subsequent group generation module. The system models an exchange frequency between employees as an edge weight using a graph neural network. The system sets an objective function that preferentially connects nodes having an edge weight equal to or less than a predetermined threshold. The system outputs a group assignment matrix that minimizes the objective function using an optimization solver. The system drives a state transition engine according to a life cycle of the event. The system dispatches a necessary task to an asynchronous worker in each state. By this process, the system seamlessly automates all processes from event planning to post-processing. The system completely eliminates manual data transfer errors. This function is applied to a use case of operating a company-wide kickoff meeting on a scale of thousands of people or a regular inter-departmental exchange meeting. This function brings about a technical effect of dramatically reducing man-hours required for event operation. This function exhibits a technical effect of saving computational resources by an algorithm that approximately solves a complex constraint satisfaction problem within polynomial time.

In addition, the AI can also be utilized for event effect measurement and KPI management. For example, the AI automatically collects and analyzes the number of posts on the internal SNS before and after the event, the number of project proposals, employee satisfaction questionnaire results, a turnover rate, the number of inter-departmental collaborations, and the like, and quantitatively visualizes the effect of the event. Based on these data, the AI can automatically generate and distribute to the management layer and the personnel department reports such as “the satisfaction level of the alumni event participants is 4.5 points on average (out of 5 points)”, “new project proposals increased by 5 in 3 months after the event”, and “the turnover rate of the event participants decreased”. Specifically, the system receives various log data before and after the event as input data. The log data is a time-series numerical data array indicating the number of posts and the number of proposals. The system further receives, as input data, binary data of a turnover flag extracted from a personnel database. The system executes causal inference using the event holding as an intervention variable by using a time-series analysis model. The system applies a difference-in-differences method or a propensity score matching algorithm to eliminate the influence of confounding factors. The system generates a statistical value indicating a fluctuation amount of the KPI as output data. The system further generates a correlation coefficient and a p-value indicating the strength of a causal relationship between the event and each KPI as output data. The system passes these output data to a report generation module. The report generation module converts the numerical data into JSON data for graph drawing. The system synthesizes a text paragraph explaining the statistical value using a natural language generation model. The system integrates the generated graph and text to construct a dashboard in a PDF format or an HTML format. By this process, the system sublimates intuitive effect measurement into evaluation based on strict statistical grounds. The system supports planning of data-driven personnel measures. This function is applied to a use case of reporting return on investment in a management meeting or budgeting for the next fiscal year. This function brings about a technical effect of automating complex statistical analysis and enabling even a user without specialized knowledge to use advanced analysis results. This function exhibits a technical effect of shortening an aggregation time of large-scale log data using a distributed processing framework.

As described above, in the embodiment of the present invention, by realizing the personnel data management unit, the group generation unit, and the communication promotion unit on the server, and realizing the user interface unit on the terminal, it is possible to provide an automated and streamlined past department alumni communication system with generative AI as a core, and to realize reconstruction of bonds among employees, strengthening of cross-departmental cooperative relationships, and improvement of company-wide engagement and productivity. Furthermore, by utilizing the AI, overwhelming efficiency, optimization, and personalization become possible compared to conventional manual grouping and event operation, resulting in an extremely useful system that contributes to strengthening the competitiveness of a company. Specifically, the system adopts a cloud-native architecture and links each module loosely coupled. The system facilitates integration with an external system via an API gateway. The system partially offloads an inference pipeline of a machine learning model to an edge computing environment. The system receives metrics data indicating a load status of the entire system as input data. The system generates a trigger signal for auto-scaling as output data. The system dynamically increases or decreases the number of container replicas based on the trigger signal. The system performs distributed transaction control in data persistence to guarantee consistency. The system periodically executes a model retraining pipeline to continuously improve inference accuracy. By this process, the system functions as an autonomous information processing infrastructure that adapts to dynamic changes in an organization beyond a mere business efficiency tool. The system eliminates human errors and ensures reproducibility of processing. This function is applied to a use case of large-scale human resource integration accompanying rapid organizational restructuring or M&A. This function brings about a technical effect of dramatically improving scalability and fault tolerance of the system. This function exhibits a technical effect of maximizing utilization efficiency of hardware resources and minimizing operation costs.

### System Configuration

The system according to the present embodiment includes a personnel data management unit, a group generation unit, a communication promotion unit, a user interface unit, an event management unit, a feedback analysis unit, and an AI prompt generation unit. The personnel data management unit is a unit that centrally stores and manages, as a database, all personnel-related information such as employee names, employee numbers, affiliated departments, department assignment start dates and end dates, job titles, contact information, transfer histories, retirement histories, project participation histories, internal award histories, evaluation histories, skill information, qualification information, past alumni event participation histories, exchange histories on an internal SNS, and internal questionnaire results. For example, when employee A was enrolled in the development department from April 2017 to March 2019, then enrolled in the sales department from April 2019 to March 2022, and transferred to the personnel department in April 2022, all of this information is recorded in chronological order. In addition, when employee A participated in a new business project in 2018, received an internal award in 2019, and acquired a qualification in 2020, this information is also linked. Furthermore, the personnel data management unit can automatically update information in real time by API linkage with an external personnel system, attendance management system, evaluation system, internal SNS, mail server, and the like. For example, when an employee acquires a new qualification, the information is automatically reflected in the database. Furthermore, the posting history of the employee on the internal SNS and the past alumni event participation history are also automatically imported. In addition, the project participation history of the employee, internal questionnaire results, and the like are also integratedly managed, and multifaceted information of the employee is comprehensively retained. Specifically, the personnel data management unit implements an ETL pipeline that performs extraction, transformation, and loading processes. The personnel data management unit constructs a data lake and accumulates structured data and unstructured data in a raw state. The personnel data management unit receives an update payload in a JSON format transmitted from an external system as input data. The update payload includes a key-value pair of an employee ID and a changed attribute value. The personnel data management unit generates a transaction log of the database as output data. The personnel data management unit asynchronously transfers the transaction log to a replication server. The personnel data management unit adopts a document-oriented database that dynamically responds to schema evolution of data. The personnel data management unit performs morphological analysis on text data to construct a full-text search index. By this process, the personnel data management unit completely prevents data silos. The personnel data management unit always provides a single source of truth that is up-to-date and accurate. This function is applied to a use case of integrating a global human resource database in a multinational corporation. This function brings about a technical effect of shortening a data synchronization delay to the order of milliseconds. This function exhibits a technical effect of dramatically improving a response time to a complex query.

The group generation unit is a unit that analyzes the enormous amount of personnel information stored in the personnel data management unit using generative AI, automatically extracts employees who were enrolled together in a specific department during a specific period, groups the corresponding employees, identifies a managerial employee from within the group, and sets the managerial employee as a leader. For example, based on an instruction such as “group employees who were enrolled in the development department from 2019 to 2020”, the AI extracts the corresponding employees. Furthermore, it can also respond to complex conditions and ambiguous instructions, such as “employees who were enrolled in the same department overlapping for one year or more”, “employees who have experience of collaborating a plurality of times in the same project”, and “employees who have interacted in an alumni event in the past”. For example, it flexibly responds to a condition such as “extract only employees who were enrolled in the sales department from 2018 to 2020 and are currently transferred to another department”. When a plurality of managerial employees exist, the group generation unit comprehensively evaluates job title hierarchies, enrollment periods, past leader experiences, project leader histories, internal award histories, and the like, and automatically selects an optimal leader. For example, when a plurality of managerial employees such as a “department manager”, a “section manager”, and a “leader” exist in a group, the AI sets the current department manager as the leader, but when the department manager is busy and cannot participate, the AI sets the section manager or a general employee having a long enrollment period as an alternative leader. Furthermore, grouping across a plurality of departments or projects is also possible, and the AI automatically executes grouping combining a plurality of conditions, such as “employees who have experience of being enrolled in both the development department and the sales department from 2017 to 2019” and “all employees involved in a new business project in 2018”. The group generation unit also refers to past collaboration histories among employees, exchange histories on the internal SNS, past alumni event participation histories, internal questionnaire results, and the like, and proposes a group configuration that maximizes group affinity and exchange effects. For example, optimization is also possible, such as preferentially grouping team members who obtained high evaluations in the same project in the past, or organizing a group centering on employees who had a high participation rate in past alumni events. Specifically, the group generation unit receives a multidimensional feature vector of an employee as input data. The group generation unit projects a high-dimensional vector into a low-dimensional space using principal component analysis or a t-SNE algorithm. The group generation unit executes a density-based spatial clustering algorithm to form a cluster while removing noise. The group generation unit generates an array of cluster IDs to which each employee belongs as output data. The group generation unit further generates a centroid vector of each cluster as output data. The group generation unit extracts an employee having a feature vector closest to the centroid vector as a leader candidate. The group generation unit inputs attribute data of the extracted leader candidate into an evaluation function to determine a final leader. By this process, the group generation unit automatically discovers a meaningful group from a data group having a non-linear relationship. The group generation unit realizes fair group organization eliminating human bias. This function is applied to a use case of optimal team building at the time of large-scale organizational restructuring. This function brings about a technical effect of reducing a calculation amount of clustering processing and improving a processing speed. This function exhibits a technical effect of optimizing calculation in a high-dimensional space and suppressing memory consumption.

The communication promotion unit is a unit that automatically transmits, using generative AI, notifications of alumni events, participation requests, instructions for organizing the events to the leader, guidance on subsidies for communication expenses provided by the company, and guidance on using an online meeting system to the grouped employees and the leader using various communication means such as an internal SNS, e-mail, a chat tool, an internal portal site, calendar linkage, a smartphone notification, a web push notification, and voice assistant linkage. For example, it automatically generates a notification text such as “To everyone in the 2018 development department alumni group, we will hold an alumni event using an online meeting tool on [Date]. If you wish to participate, please register from the following link”, and transmits it to the terminal of each member. It also transmits an individual instruction to the leader, such as “You are requested to organize the event as a group leader. The AI will support confirmation of attendance of participants, adjustment of agenda items, and the like.” The notification text can also be personalized and automatically generated by the AI according to employee attributes, past participation histories, and working styles (remote work, on a business trip, etc.). For example, before the event is held, the AI manages the attendance status of the participants in real time and automatically distributes a progress report to the leader and the administrator. On the day of the event, the AI links with the online meeting system and executes automatic generation of a participant list, automatic distribution of a meeting link, entry/exit management of participants, automatic display of agenda items, Q&A response by a chatbot, automatic generation of minutes, automatic saving of recorded video/audio data, and the like. For example, the AI provides progress support such as “Today's agenda is XX. If you have any questions, please enter them in the chat. The AI will automatically answer.” Specifically, the communication promotion unit receives a profile vector of each employee and a context vector of the event as input data. The communication promotion unit executes a fine-tuned natural language generation model. The model weights a specific element of the profile vector using an attention mechanism. The model generates a notification text optimized for each employee as output data. The model further generates a score array indicating a priority of a transmission channel as output data. The communication promotion unit selects a channel with the highest score to construct an API request. The communication promotion unit transmits the constructed request to an external communication gateway. The communication promotion unit executes a retransmission process using an exponential backoff algorithm when detecting a transmission error. By this process, the communication promotion unit maximizes a message arrival rate. The communication promotion unit realizes optimal information presentation according to a user context. This function is applied to a use case of reliable information transmission to employees having diverse working styles. This function brings about a technical effect of preventing wasteful consumption of communication resources. This function exhibits a technical effect of improving fault tolerance in linkage between systems.

The user interface unit is realized on a terminal used by an employee or a managerial employee, and is a unit that provides a screen on which notifications and guidance transmitted from the server, event participation registration, feedback answers, and the like can be intuitively operated. For example, using a smartphone, a browser of a personal computer, a dedicated application, or the like, it is possible to confirm event details, register participation availability, interact in advance via chat, participate in an online meeting on the day, answer a questionnaire, and the like. The user interface unit can also display guidance texts and FAQs generated by the AI, past event histories, participant lists, and the like in real time. For example, a function that allows an employee to confirm “what kind of alumni events were held in the past”, “which group they belong to”, “profiles of event participants”, and the like can also be implemented. Furthermore, the user interface unit includes a chatbot function by the AI, and can provide questions regarding the event, guidance on operation methods, support for participation registration, and the like in real time. Specifically, the user interface unit adopts a component-based architecture to make UI parts reusable. The user interface unit centrally manages a data flow of the entire application using a state management library. The user interface unit receives stream data of a screen scroll amount and click coordinates of a user as input data. The user interface unit generates a screen redraw command and an asynchronous request to the server as output data. The user interface unit directly executes a natural language processing model as WebAssembly on a browser in the chatbot function. Thereby, the user interface unit generates a response text to a basic question without communication with the server. The user interface unit transfers only a complex question to an inference engine on the server side. By this process, the user interface unit reduces consumption of a network bandwidth. The user interface unit suppresses a feedback delay to a user operation to the order of milliseconds. This function is applied to a use case of use in a mobile environment where a communication environment is limited. This function brings about a technical effect of effectively utilizing computational resources on the client side and distributing a load on the server. This function exhibits a technical effect of enabling a certain level of service continuation even in an offline state.

The event management unit is a unit that supervises a series of operations related to event operation, such as event planning, schedule adjustment, venue reservation, online meeting system linkage, participant management, progress management, agenda setting, material distribution, and operation support on the day of the event. For example, it has a wide variety of functions, such as the AI automatically analyzing schedules of participants and proposing an optimal holding schedule, automatically searching for availability of a venue and making a reservation, automatically issuing an account for an online meeting system and distributing a link, automatically generating a progress chart and an agenda list on the day of the event, managing entry/exit of participants in real time, and automatically distributing minutes and recorded data after the event ends. For example, the AI executes processes such as “analyzing calendars of all participants and automatically proposing a date and time when the largest number of people can participate”, “linking with a venue reservation system and automatically reserving an optimal meeting room”, “automatically issuing an account for an online meeting system and distributing a link to participants”, and “automatically generating a progress chart and an agenda list on the day of the event and distributing them to participants”. Specifically, the event management unit receives a free time matrix acquired from calendar systems of all participants as input data. The free time matrix is a two-dimensional binary array with participants as rows and time frames as columns. The event management unit executes an optimization algorithm functioning as a solver for a constraint satisfaction problem. The algorithm considers job titles of participants and mandatory participation flags as weighting parameters. The event management unit generates a candidate list of optimal holding dates and times as output data. The candidate list is an array of timestamps. The event management unit further generates a fitness score of each candidate as output data. The event management unit selects a date and time with the highest score and transmits an API call of a reservation request to the calendar system. The event management unit simultaneously calls an API of a facility management system to lock a resource of a meeting room. The event management unit executes a state machine during the progress of the event to track a current progress status. By this process, the event management unit completely automates a complex schedule adjustment task. The event management unit eliminates human errors such as double booking. This function is applied to a use case of setting an important meeting in which a large number of stakeholders including executives participate. This function brings about a technical effect of shortening a lead time required for adjustment from several days to several seconds. This function exhibits a technical effect of safely processing a distributed transaction among a plurality of systems.

The feedback analysis unit is a unit that automatically analyzes feedback collected from participants after an event ends using generative AI, and performs effect measurement of the event, satisfaction evaluation, improvement point extraction, new idea extraction, proposals for the next event, and the like. For example, a questionnaire such as “Please let us know your opinions, such as what you gained by participating in this alumni event, new ideas, and future improvement points” is automatically generated, and answers are collected through a user interface unit of a terminal. The AI automatically analyzes the collected feedback, and automatically distributes quantitative and qualitative analysis results, such as “the satisfaction of the event participants was high”, “a plurality of ideas for new projects were born”, and “there are many voices desiring face-to-face holding next time”, to an administrator or a leader as a report. Furthermore, the AI can also automatically propose an optimal holding time, holding format, group configuration, agenda candidates, and the like for the next event based on past feedback histories, event participation histories, and employee attribute information. For example, analysis results such as “the holding format with the highest satisfaction in the past three events was an online format” and “the group configuration with a large number of proposals for new project ideas was a mixed type of different departments” are automatically generated. Specifically, the feedback analysis unit receives a text corpus of questionnaire answers as input data. The feedback analysis unit further receives an attribute vector of a respondent as input data. The feedback analysis unit executes a sentiment analysis pipeline in which a pre-trained language model is fine-tuned. The pipeline calculates a tensor of an emotion score for each sentence in the text. The feedback analysis unit extracts a topic distribution matrix from the text corpus using a latent Dirichlet allocation method. The feedback analysis unit generates an array of importance scores of each topic as output data. The feedback analysis unit further generates a summary text of the extracted new ideas as output data. The feedback analysis unit dynamically generates a highlight portion of the report based on the importance score. The feedback analysis unit performs a trend analysis by comparing a past score history accumulated in a time-series database with a current score. The feedback analysis unit outputs the analysis result as structured data in a JSON format and passes it to a visualization module. By this process, the feedback analysis unit automatically extracts a quantitative KPI from unstructured data. The feedback analysis unit strongly supports data-driven decision making. This function is applied to a use case of a quick review after a large-scale event or planning of a next measure. This function brings about a technical effect of optimizing a calculation cost in natural language processing and processing a large amount of text data at high speed. This function exhibits a technical effect of improving the accuracy of text mining and reducing noise.

The AI prompt generation unit is a unit that automatically generates a prompt sentence for giving an appropriate instruction or question to the generative AI, and optimizes the output accuracy and response quality of the AI. For example, specific prompt sentences such as “extract employees who were enrolled in the development department from 2019 to 2020 and group them”, “list employees who have project leader experience in the sales department in the past three years”, “group employees who were enrolled together in the same department for one year or more”, “extract new project ideas from feedback of event participants”, and “analyze a holding format with high satisfaction in past alumni events” are automatically generated and input to the AI. Furthermore, the AI prompt generation unit can analyze intentions and purposes of an administrator or a user, past operation histories, event situations, and the like, and generate an optimal prompt sentence in real time. For example, advanced prompt control is realized, such as “automatically generating a prompt for feedback analysis when the administrator desires effect measurement of the event” and “generating a prompt for decomposing conditions and sequentially instructing the AI when grouping conditions are complex”. Specifically, the AI prompt generation unit maps an input text of the user and a system state to a multidimensional vector space. The AI prompt generation unit analyzes the intention of the input data using a natural language processing model. The natural language processing model includes an encoder network based on a transformer architecture. The encoder network converts the input text into a 768-dimensional context vector. The AI prompt generation unit acquires a past operation history as a time-series tensor. The AI prompt generation unit combines the context vector and the time-series tensor. The AI prompt generation unit inputs the combined feature amount tensor to a decoder network. The decoder network outputs a probability distribution of a token sequence constituting an optimal prompt sentence. The AI prompt generation unit selects a token sequence having the highest probability. The AI prompt generation unit decodes the selected token sequence into character string data. The character string data functions as an input prompt to a large language model. The AI prompt generation unit transfers the generated prompt to an input layer of the large language model. The large language model executes an inference process based on the received prompt. With this configuration, the system eliminates trial and error by humans. The system automates prompt engineering. The system dramatically improves the inference accuracy of the large language model. The system suppresses wasteful consumption of calculation resources due to an inappropriate prompt. The system is particularly effective in a complex personnel data extraction task. The system generates a highly accurate data extraction query even from an ambiguous instruction of the user. The AI prompt generation unit continuously updates a prompt generation policy using reinforcement learning. A reward function of the reinforcement learning is based on an evaluation score of the user for an output result of the large language model. The AI prompt generation unit increases a generation probability of a prompt having a high evaluation score. The AI prompt generation unit decreases a generation probability of a prompt having a low evaluation score. By this process, the system improves the optimization accuracy of the prompt as the operation period becomes longer. The AI prompt generation unit generates a plurality of prompt candidates in parallel. The AI prompt generation unit calculates a predicted response quality score for each candidate. The AI prompt generation unit selects a prompt candidate having the maximum predicted response quality score as a final output. The predicted response quality score is calculated as a floating-point number in a range of 0.0 to 1.0. When the predicted response quality score falls below a predetermined threshold value, the AI prompt generation unit executes a prompt regeneration process. The regeneration process promotes diverse outputs by adding minute noise to an input feature amount. The system executes these advanced arithmetic processes at high speed on a dedicated arithmetic accelerator.

In this way, the system according to the present embodiment includes the personnel data management unit, the group generation unit, the communication promotion unit, the user interface unit, the event management unit, the feedback analysis unit, and the AI prompt generation unit, and each unit cooperates to realize automation, optimization, and sophistication of past department alumni event communication, and enables overwhelming efficiency and personalization compared to conventional manual operation by utilizing generative AI. Specifically, the system implements each unit as a microservice based on a distributed computing architecture. The system includes an integrated messaging bus for seamlessly linking data among the respective units. The system receives an asynchronous message from each unit as an input. The system analyzes a payload of the message and routes it to an appropriate processing unit. The system outputs a state update signal of the entire system. The system executes a synchronization process of each database based on the state update signal. With this configuration, the system reduces the latency of the entire system to the utmost limit. The system maintains high throughput even when the number of simultaneously connected users increases. The system eliminates a single point of failure and guarantees high availability. The system enables each processing unit to scale independently. The system is optimal for a use case of processing employee data of tens of thousands of people in real time in a large-scale corporate network environment. The system aggregates processing logs of the respective units into a centralized logging server. The system inputs the aggregated log data to a machine learning model, and automatically detects a performance bottleneck of the system. The system executes dynamic allocation of computing resources based on the detection result. The system maximizes the utilization efficiency of hardware resources.

### Implementation Steps

### Step 1: Collection and Integration of Personnel Data

In the personnel data management unit on the server, all personnel-related information such as employee names, employee numbers, affiliated departments, department assignment start dates and end dates, job titles, contact information, transfer histories, retirement histories, project participation histories, internal award histories, evaluation histories, skill information, qualification information, past alumni event participation histories, exchange histories on an internal SNS, and internal questionnaire results is centrally collected and integrally managed as a database. For example, API linkage is performed with an external personnel system, attendance management system, evaluation system, internal SNS, mail server, and the like, and information such as employee transfers, qualification acquisitions, and project participation is automatically reflected in real time. Specifically, the personnel data management unit is configured as a distributed database system. The personnel data management unit executes asynchronous communication with a plurality of external systems. The personnel data management unit receives data via an application programming interface gateway. The received data includes text data in a JSON format or an XML format. The personnel data management unit parses the received text data. The personnel data management unit removes unnecessary noise from the parsed data. The personnel data management unit complements a missing value using a statistical method. The personnel data management unit maps the preprocessed data to a high-dimensional vector space. The personnel data management unit expresses employee attribute information as a 512-dimensional numerical vector. The personnel data management unit constructs relationships among employees as nodes and edges on a graph database. The node represents an individual employee. The edge represents a collaboration history among employees or a sharing relationship of an affiliated department. A weight value indicating the strength of the relationship is assigned to the edge. The weight value is calculated as a floating-point number in a range of 0.0 to 1.0. The personnel data management unit integrally stores these structured data and unstructured data. With this configuration, the system strictly maintains data consistency. The system dramatically improves the speed of a search process based on a complex relationship. The system enables advanced pattern recognition that has been difficult with a conventional relational database. The system eliminates siloing of personnel data in a large-scale organization. The system provides a foundation for realizing data-driven talent management. The personnel data management unit records an update history of data in a tamper-proof state using blockchain technology. By this process, the system ensures the reliability of an audit trail. The personnel data management unit periodically transfers a backup of data to a remote storage server. The system guarantees quick data recovery when a failure occurs.

### Step 2: Setting of Grouping Conditions and AI Prompt Generation

An administrator or the system specifies grouping conditions (e.g., employees who were enrolled in the development department from 2019 to 2020, employees who participated in the same project a plurality of times, employees who were enrolled together for one year or more, etc.), and the AI prompt generation unit automatically generates a prompt sentence for instructing the generative AI based on these conditions. Examples of specific prompt sentences include “extract employees who were enrolled in the development department from 2019 to 2020 and group them”, “group employees who were enrolled together in the same department for one year or more”

“list employees who have project leader experience in the sales department in the past three years”, and the like. Specifically, the AI prompt generation unit inputs a natural language text input by the administrator to a parsing engine. The parsing engine extracts an entity and a relationship from the input text. The AI prompt generation unit outputs the extracted information as a JSON object of structured condition parameters. The AI prompt generation unit passes the condition parameters to a prompt template engine. The prompt template engine generates a structured prompt character string in which the condition parameters are embedded. The AI prompt generation unit formats the generated prompt character string in accordance with an input format of a large language model. The AI prompt generation unit transfers the formatted prompt character string to a subsequent generative AI module. With this configuration, the system completely automates the analysis of complex search conditions. The system eliminates human errors of the administrator. The system guarantees that an instruction is given in a format in which the generative AI can accurately understand the intention. The system provides an environment in which a personnel department can execute advanced data extraction without learning a complex database query language. The AI prompt generation unit includes a module that verifies the logical consistency of the generated prompt. The verification module feeds back a warning message to the administrator when contradictory conditions are included. The system prevents waste of calculation resources due to an invalid query.

### Step 3: Grouping and Leader Selection by Generative AI

In the group generation unit, the generative AI analyzes the personnel database, extracts employees corresponding to the specified conditions, and executes grouping. Furthermore, a managerial employee (a department manager, a section manager, a leader, etc.) is automatically identified from within the group, and an optimal leader is selected. When a plurality of managerial employees exist, the leader is determined by comprehensively evaluating job title hierarchies, enrollment periods, leader experiences, internal award histories, and the like, and when no managerial employee exists, the AI automatically selects an employee having the longest enrollment period or a person having project leader experience. Examples of prompt sentences to be read by the generative AI include “group employees who were enrolled in the development department from 2019 to 2020, and set an employee having the highest job title in the group as a leader” and “when there are a plurality of employees corresponding to the conditions, select an optimal leader in consideration of enrollment periods and leader experiences”. Specifically, the group generation unit executes a graph neural network model. The graph neural network model receives graph structure data from the personnel data management unit as an input. The input data includes a node feature amount matrix representing employees and an adjacency matrix representing relationships among the employees. The node feature amount matrix is a multidimensional tensor in which attribute information of each employee is digitized. The group generation unit updates a node feature amount using a graph convolution layer. The graph convolution layer aggregates feature amounts of adjacent nodes. The group generation unit executes a clustering algorithm using the updated node feature amount. The clustering algorithm adopts a density-based spatial clustering method. The group generation unit assigns a node group densely clustered in a feature amount space as the same cluster. The group generation unit outputs a cluster assignment label for each employee. The group generation unit calculates a leadership score for each employee in the cluster. The leadership score is calculated by a multilayer perceptron that receives a past job title history, a project evaluation, and a network centrality index as inputs. The multilayer perceptron outputs a floating-point number in a range of 0.0 to 1.0. The group generation unit sorts the employees in descending order based on the calculated leadership scores. The group generation unit selects an employee having the maximum score as a leader. The group generation unit transfers the selection result to the subsequent communication promotion unit. With this configuration, the system realizes objective leader selection excluding human subjectivity. The system promotes discovery of hidden talent. The system improves activation of an organization and a success probability of a project. The system is particularly effective in an optimization task of large-scale personnel allocation. The group generation unit also outputs a reliability score for evaluating the validity of the selected leader. When the reliability score falls below a predetermined threshold value, the system generates an alert prompting the administrator for manual confirmation.

### Step 4: Automatic Generation and Distribution of Event Notifications and Guidance

The communication promotion unit automatically generates and distributes, using generative AI, notifications of alumni events, participation requests, instructions for organizing the events to the leader, guidance on subsidies for communication expenses provided by the company, guidance on using an online meeting system, and the like to the grouped employees and the leader using various communication means such as an internal SNS, e-mail, a chat tool, an internal portal site, calendar linkage, a smartphone notification, and a web push notification. For example, the AI automatically generates a guidance text such as “To everyone in the 2019 development department alumni group, an alumni event will be held on an online meeting tool on [Date]. Those who wish to participate, please register from the following link”, and transmits it to the terminal of each member. Examples of prompt sentences to be read by the generative AI include “generate an event guidance text for the grouped employees, and create an individual instruction text including a request for organizing for the leader” and “personalize the guidance text according to working styles and past participation histories of participants”. Specifically, the communication promotion unit executes a natural language generation model. The natural language generation model is an autoregressive neural network based on a transformer architecture. The communication promotion unit inputs metadata of the event and attribute vectors of the participants to the model. The metadata of the event is structured data including a holding date and time, a purpose, and an agenda. The attribute vector is a tensor in which past participation histories and interest areas of the participants are digitized. The natural language generation model generates a token sequence of a personalized guidance text based on the input data. The model calculates an appearance probability of each token and sequentially selects the most appropriate word. The communication promotion unit decodes the generated token sequence into a natural language text character string. The communication promotion unit transmits the generated text character string to a messaging application programming interface. The interface registers a transmission request in an asynchronous communication queue. The system distributes the message registered in the queue to each terminal at an appropriate timing. With this configuration, the system completely eliminates human costs required for creating notifications. The system dramatically improves the participation rate in the event by providing a message optimized for each participant. The system has an ability to process a large amount of messages in parallel without delay. The communication promotion unit tracks an open rate and a click rate of the transmitted message. The communication promotion unit utilizes tracking data as a reward signal of a reinforcement learning algorithm. The system autonomously improves the appeal of the message through continuous learning.

### Step 5: Event Operation and Progress Support

The event management unit supervises event planning, schedule adjustment, venue reservation, online meeting system linkage, participant management, progress management, agenda setting, material distribution, operation support on the day of the event, and the like. The generative AI performs a wide variety of operation support, such as automatically analyzing schedules of participants and proposing an optimal holding schedule, automatically searching for availability of a venue and making a reservation, automatically issuing an account of an online meeting system and distributing a link, automatically generating a progress chart and an agenda list on the day of the event, managing entry and exit of participants in real time, and automatically distributing minutes and recorded data after the event ends. Examples of prompt sentences to be read by the generative AI include “analyze calendars of all participants and propose a date and time when the largest number of people can participate”, “automatically generate an event progress chart and an agenda list”, and “issue a link of an online meeting system and distribute it to participants”. Specifically, the event management unit executes an advanced schedule optimization algorithm. The event management unit acquires free time information from calendar systems of all participants. The event management unit constructs the acquired information as a multidimensional binary tensor. In the binary tensor, a value of 1 represents free time, and a value of 0 represents having a schedule. The event management unit searches for an optimal holding date and time using a constraint satisfaction problem solver. The solver incorporates priorities of participants and conditions of essential participants as constraint expressions. The event management unit outputs a probability distribution of a plurality of candidate dates and times. The event management unit determines a date and time having the highest probability as the optimal holding date and time. The event management unit transmits a reservation confirmation signal to a venue reservation system based on the determined date and time. The event management unit automatically generates a uniform resource locator of a virtual meeting room in cooperation with the online meeting system. The event management unit distributes the generated locator to terminals of the participants. With this configuration, the system instantly completes a complex schedule adjustment task. The system avoids resource conflicts and maximizes the utilization rate of meeting rooms. The system dramatically reduces preparation time for event operation. The event management unit monitors a progress status on the day of the event in real time. When the progress of a scheduled agenda is delayed, the event management unit automatically transmits an alert message prompting progress to the terminal of the leader. The system technically ensures smooth progress of the event.

### Step 6: Event Participation, Exchange, and Real-Time AI Support

Through the user interface unit, employees and managerial employees perform detailed confirmation of the event, registration of participation availability, preliminary exchange by chat, online meeting participation on the day, questionnaire answering, and the like. During the event, the generative AI performs support such as creating minutes in real time, immediately answering questions from participants as a chatbot, and immediately presenting past collaboration histories and project materials. For example, the AI implements progress support such as “Today's agenda is XX. If you have any questions, please enter them in the chat. The AI will automatically answer”. Examples of prompt sentences to be read by the generative AI include “summarize utterance contents during the event as minutes in real time”, “automatically answer questions from participants by referring to an FAQ database”, and “present related materials based on past collaboration histories”. Specifically, the user interface unit executes a pipeline of real-time speech recognition and natural language understanding. The user interface unit receives audio stream data from terminals of the participants. The user interface unit converts the audio data into Mel-frequency cepstral coefficients. The user interface unit inputs the converted acoustic feature amounts to a speech recognition neural network. The speech recognition neural network converts the acoustic feature amounts into a text-based utterance log. The user interface unit inputs the utterance log to a natural language understanding model. The natural language understanding model classifies an intention of an utterance and outputs an intention classification label. When the intention classification label indicates a question, the user interface unit vectorizes the question content. The user interface unit searches a knowledge database using the vectorized question. This search process is performed by calculating a cosine similarity between a question vector and an answer vector in the database. The user interface unit extracts an answer text having the highest similarity. The user interface unit immediately displays the extracted answer text on a chat interface. With this configuration, the system resolves questions during a meeting in real time. The system significantly reduces the burden on a human facilitator. The system improves the productivity of the meeting and the satisfaction of the participants. The user interface unit extracts an important keyword from the utterance log in real time. The user interface unit automatically searches for past project materials related to the extracted keyword and presents them on a screen. The system autonomously executes information provision according to a context.

Step 7: Feedback collection, analysis, and reporting. After the event ends, a feedback analysis unit transmits a feedback request to all participants using generative AI, and collects questionnaire and free-text answers. The AI automatically analyzes the collected feedback, performs event effect measurement, satisfaction evaluation, improvement point extraction, new idea extraction, proposals for the next event, and the like, and automatically distributes them as a report to an administrator and the leader. For example, the AI automatically generates analysis results such as “the satisfaction of the event participants was high”, “a plurality of ideas for new projects were generated”, and “there are many requests for holding the next event face-to-face”. Examples of prompt sentences to be read by the generative AI include “extract satisfaction, improvement points, and new ideas from the feedback of the event participants and summarize them as a report” and “compare with past feedback histories and analyze the characteristics of this event”. Specifically, the feedback analysis unit quantifies qualitative data using an advanced natural language processing algorithm. The feedback analysis unit converts the collected free-text text into a word embedding vector. The feedback analysis unit inputs the word embedding vector into a sentiment analysis model. The sentiment analysis model adopts a recurrent neural network architecture. The sentiment analysis model outputs a sentiment polarity of the text as a sentiment score in a range from minus 1.0 to plus 1.0. The feedback analysis unit executes topic modeling using a latent Dirichlet allocation method. The feedback analysis unit extracts a latent topic from a text data group, and outputs a keyword group representing each topic. The feedback analysis unit integrates the sentiment score and the extracted keyword group as structured data. The feedback analysis unit drives a report generation module using the integrated data. The report generation module constructs JSON data for dashboard display. The feedback analysis unit distributes the constructed data to terminals of the administrator and the leader. With this configuration, the system instantaneously analyzes a large amount of questionnaire results. The system discovers fine insights that tend to be overlooked by human visual analysis. The system enables a data-driven approach to planning the next event. The feedback analysis unit compares the analysis result of the past event and the analysis result of this time in chronological order. The feedback analysis unit statistically tests the transition of satisfaction and the occurrence tendency of new issues. The system continuously monitors the soundness of the communication state of the organization.

### Specific Use Case

For example, when implementing past department alumni communication targeting employees who were enrolled in the product planning department during the period from 2018 to 2020, first, the personnel data management unit extracts information such as employee names, employee numbers, assignment start dates and end dates to the product planning department, job titles, contact information, transfer histories, project participation histories, internal award histories, evaluation histories, skill information, qualification information, past alumni event participation histories, exchange histories on the internal SNS, and internal questionnaire results from the database, and generates a list of all employees who were enrolled in the product planning department during the corresponding period. Next, the group generation unit causes the generative AI to read a prompt sentence such as “group employees who were enrolled in the product planning department from Apr. 1, 2018 to Mar. 31, 2020, and set an employee having the highest job title in the group as a leader” from among the extracted employees using the generative AI, and executes grouping and leader selection. Here, when a plurality of managerial employees exist, the generative AI comprehensively evaluates job title hierarchies, enrollment periods, leader experiences, internal award histories, and the like, and automatically determines an optimal leader. Specifically, the personnel data management unit converts a natural language search query into a structured database query language. The personnel data management unit cross-searches a relational database and a graph database using the converted query. The personnel data management unit outputs an array of identifiers of employees matching the condition. The personnel data management unit constructs attribute data of the extracted employees as a high-dimensional tensor. The personnel data management unit transfers the constructed tensor to the group generation unit. The group generation unit inputs the received tensor into a graph neural network. The graph neural network learns past collaboration histories and skill similarities among employees as edge weights. The group generation unit executes an algorithm for detecting a community structure in the network. The group generation unit outputs an optimal group division pattern. The group generation unit calculates a centrality index of a node in each group. The group generation unit calculates an influence score of each employee by applying a PageRank algorithm. The group generation unit selects an employee having the highest influence score as the leader. With this configuration, the system realizes rapid data extraction based on a complex condition. The system enables advanced grouping considering not only simple attribute matching but also the strength of potential human relations. The system is extremely effective in large-scale organizational restructuring and project team formation. The group generation unit assigns a category label indicating a leadership style to the selected leader. The category label is determined by a classification model based on past evaluation data. The system places human resources having a leadership style most suitable for the characteristics of the group in the right places.

The communication promotion unit automatically generates, using generative AI, notification texts such as “To everyone in the alumni group who was enrolled in the product planning department from 2018 to 2020, an alumni event will be held on an online meeting tool on [Date]. Those who wish to participate should register from the following link” and “The leader is requested to organize the event and support confirmation of attendance of participants and agenda adjustment” for the grouped employees and the leader, and distributes them to the terminal of each member using an internal SNS, e-mail, a chat tool, an internal portal site, calendar linkage, a smartphone notification, or the like. Furthermore, as guidance on subsidies for communication expenses provided by the company, the generative AI automatically creates a guidance text to the effect that “this event is subject to the company's communication expense subsidy system, and the company will bear food and drink expenses, venue expenses, and online meeting system usage fees”, and distributes it to the participants. Specifically, the communication promotion unit integrates and processes a user profile vector and rule-based data of the subsidy system. The communication promotion unit acquires a profile vector in which the job title, past event participation frequency, and communication style of each employee are quantified. The communication promotion unit reads rule-based data expressing regulations regarding the company's subsidy system as a logical expression. The communication promotion unit embeds these input data as a prompt context of a large language model. The large language model generates a message character string optimized for each recipient based on the input context. The communication promotion unit automatically adjusts the tone and manner of the generated message character string. The communication promotion unit selects a formal expression for a managerial employee, and selects a casual expression for a general employee. The communication promotion unit transfers the generated message to a multi-channel distribution engine. The distribution engine determines a communication channel most frequently used by each employee using a prediction model. The distribution engine transmits the message through the determined optimal channel. With this configuration, the system eliminates uniform simultaneous transmission and realizes highly personalized information provision. The system improves the utilization rate of the subsidy system provided by the company. The system strongly promotes the activation of internal communication. The communication promotion unit collects a click event of a link embedded in the message in real time. The communication promotion unit analyzes the collected event data and evaluates the effectiveness of the message. The system feeds back the evaluation result to the next message generation process to achieve continuous improvement.

An event management unit automatically analyzes schedules of the participants using generative AI, causes the generative AI to read a prompt sentence “analyze calendars of all participants and propose a date and time when the largest number of people can participate”, and determines an optimal holding schedule. The event management unit provides operational support such as automatically searching for and reserving availability of a venue, automatically issuing an account of an online meeting system and distributing a link, automatically generating a progress schedule and an agenda list on the day of the event, managing entry and exit of participants in real time, and automatically distributing minutes and recorded data after the event ends. For example, the event management unit causes the generative AI to read prompt sentences such as “automatically generate an event progress schedule and an agenda list and distribute them to participants” and “issue a link of an online meeting system and distribute it to participants”. Specifically, the event management unit integrally analyzes schedule tensors of a plurality of users. The event management unit extracts calendar data of each user as a time-series binary array. The event management unit combines the extracted arrays as a matrix to construct a schedule tensor. The event management unit inputs the schedule tensor into a convolutional neural network. The convolutional neural network extracts a pattern of free time along a time axis. The event management unit applies a weighting coefficient based on job titles of participants and essential participation conditions. The event management unit outputs an array of fitness scores for each time slot. The event management unit selects a time slot having the maximum fitness score as the optimal holding date and time. The event management unit calls an application programming interface of the online meeting system based on the selected date and time. The event management unit dynamically generates an instance of a virtual meeting room. The event management unit encrypts connection information of the generated instance and distributes it to the participants. The event management unit automatically generates the progress schedule of the event as structured data. With this configuration, the system completely automates complex schedule adjustment among a large number of people. The system dramatically shortens a lead time required for adjustment from several days to several seconds. The system guarantees holding of the event at an optimal timing and maximizes a participation rate. The event management unit analyzes past lateness histories and meeting extension tendencies of the participants using a machine learning model. The event management unit automatically calculates a buffer time of the meeting based on the analysis result, and incorporates it into the schedule. The system realizes flexible and robust schedule management in line with actual operation.

A user interface unit provides a screen for an employee or a managerial employee to perform detailed confirmation of the event, registration of participation availability, preliminary exchange by chat, participation in the online meeting on the day, questionnaire answering, and the like using a terminal, and also displays a guidance text and FAQ generated by the AI, past event histories, a participant list, and the like in real time. During the event, the generative AI creates minutes in real time, causes the generative AI to read a prompt sentence “summarize utterance contents during the event as minutes in real time”, immediately answers questions from participants as a chatbot, and uses a prompt sentence “automatically answer questions from participants by referring to an FAQ database”. Furthermore, in order to immediately present past collaboration histories and project materials, the generative AI is caused to read a prompt sentence “present related materials based on past collaboration histories”. Specifically, the user interface unit establishes a bidirectional real-time data stream with the server using WebSocket communication. The user interface unit captures a screen operation and a keyboard input of a user as an event stream. The user interface unit instantaneously transmits the captured event stream to a processing module on the server side. The user interface unit asynchronously receives a screen update command from the server. The user interface unit dynamically rewrites a document object model based on the received command. The user interface unit integrates a chatbot module. The chatbot module receives a question text in natural language from the user. The chatbot module vectorizes the question text and generates an answer based on semantic similarity. The user interface unit immediately renders the generated response text in a chat window. The user interface unit prefetches metadata of past collaboration histories and related materials in the background. The user interface unit automatically pops up and displays a thumbnail of the related material on a sidebar of the screen in accordance with the context of the conversation. With this configuration, the system provides an extremely responsive and intuitive operation environment. The system reduces a cognitive load of the user and enhances a sense of immersion in the event. The system autonomously presents necessary information at a necessary timing. The user interface unit collects line-of-sight movement and mouse tracking data of the user. The user interface unit visualizes the collected data as a heat map, and utilizes it for layout optimization of the user interface. The system includes a self-evolution mechanism for continuously improving user experience.

After the event ends, the feedback analysis unit transmits a feedback request to all participants using generative AI, automatically generates a questionnaire “Please let us know your opinions, such as what you gained by participating in this alumni event, new ideas, and future improvement points”, and collects answers through the user interface unit of the terminal. The AI automatically analyzes the collected feedback, causes the generative AI to read prompt sentences such as “extract satisfaction, improvement points, and new ideas from the feedback of the event participants and summarize them as a report” and “compare with past feedback histories and analyze the characteristics of this event”, performs event effect measurement, satisfaction evaluation, improvement point extraction, new idea extraction, proposals for the next event, and the like, and automatically distributes them as a report to the administrator and the leader. Specifically, the feedback analysis unit generates a dynamic questionnaire form based on a context vector of the event. The context vector is a multidimensional tensor including an agenda of the event, attributes of participants, and a summary of an utterance log during the meeting. The feedback analysis unit inputs the context vector into a questionnaire generation neural network. The network outputs a list of question items optimized for each participant as structured data. The feedback analysis unit renders the structured data as a web form and distributes it to each terminal. The feedback analysis unit inputs the collected answer data into a natural language processing pipeline. The pipeline executes morphological analysis, syntactic analysis, and named entity extraction. The feedback analysis unit performs clustering using the extracted feature amounts, and generates an insight vector of new ideas and improvement points. The feedback analysis unit converts the insight vector into a summary text in natural language. The feedback analysis unit integrates the summary text and a quantitative satisfaction score to construct a comprehensive evaluation report. With this configuration, the system eliminates a uniform questionnaire and significantly improves an answer rate and answer quality. The system automatically extracts an actionable business insight from an enormous amount of qualitative data. The system visualizes return on investment of the event as an objective numerical value. The feedback analysis unit automatically registers the extracted new ideas in an internal innovation management database. The feedback analysis unit scores the feasibility of the ideas using a prediction model. The system functions as an idea creation platform that drives continuous growth of a company, not limited to a mere review of an event.

In this way, the respective units cooperate to realize automation, optimization, and sophistication of past department alumni communication while utilizing generative AI, thereby enabling reconstruction of bonds among employees, strengthening of cross-departmental cooperative relations, and improvement of company-wide engagement and productivity. Specifically, the system includes an integrated messaging bus for seamlessly linking data among respective modules. The system continuously collects an operation log of the entire system and user feedback. The system accumulates the collected data in a data lake. The system executes an online learning algorithm using the accumulated data. The online learning algorithm dynamically updates a weight parameter of a generative AI model. The system minimizes a loss function of the model using a backpropagation method. The system deploys the updated parameter to a production environment without downtime. The system models an action history of each user as an environmental state of an agent of reinforcement learning. The system defines an engagement score of the user as a reward signal. The system autonomously searches for an optimal communication measure that maximizes the reward. With this configuration, unlike a static rule-based system, the system adapts to environmental changes and self-evolves. The system formalizes tacit knowledge in the organization and constructs a company-wide knowledge graph. The system breaks down silos between departments and technically enforces cross-functional collaboration. The system detects a turnover risk of an employee at an early stage using a prediction model. The system automatically proposes an appropriate communication event to an employee having a high turnover risk. The system functions as an advanced computing platform for maximizing the value of human capital.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### Embodiment for Carrying Out the Present Invention

As an embodiment for carrying out the present invention, a configuration in which a server and a terminal are connected via a network in a nursing care facility or a home nursing care service office is basic, a nursing care information management unit, a group generation unit, a communication support unit, an event operation unit, a feedback analysis unit, and an AI prompt generation unit can be provided on the server side, and a user interface unit can be provided on the terminal side. Hereinafter, the configuration, function, processing flow, method of utilizing generative AI, specific usage example, and role sharing between the server and the terminal of each unit will be described extremely in detail and comprehensively. Specifically, the system adopts a hybrid architecture in which an edge computing device and a cloud server are linked. The system collects real-time data from a large number of Internet of Things sensors arranged in the nursing care facility. The sensors include a bed sensor, an environment sensor, and a wearable vital sensor. The system executes initial data filtering and abnormality detection processing on the edge device. The system transfers the preprocessed data to the cloud server via a secure communication protocol. The cloud server executes each processing unit as a microservice on a scalable container orchestration platform. The system causes a smartphone or a tablet terminal of nursing care staff to function as the user interface unit. The system executes a lightweight inference model on the terminal side, and provides basic functions even in an offline environment. With this configuration, the system establishes a robust system infrastructure that is less susceptible to network delay. The system protects nursing care data including sensitive personal information using advanced encryption technology. The system guarantees stable operation even in a harsh communication environment peculiar to a nursing care site. The system integrally analyzes the collected multimodal data, and outputs a proposal of an optimized care plan. The system quantitatively measures a workload of the nursing care staff, and generates an alert for preventing burnout. The system solves a social issue of chronic labor shortage in the nursing care industry by advanced information processing technology.

First, the nursing care information management unit is realized on the server, and centrally stores and manages, as a database, all nursing care-related information such as names, IDs, roles (nursing care staff, nurse, rehabilitation staff, registered dietitian, user family, etc.), affiliated facilities, assignment start dates and end dates, contact information, transfer histories, histories of users in charge, past exchange meeting participation histories, care case information, qualification information, evaluation information, questionnaire results, shift information, training histories, accident/near-miss report histories, exchange histories on an internal SNS, family meeting participation histories, request/complaint histories from families, user state change records, vital data, medication management histories, meal management histories, rehabilitation plan histories, and cooperation histories with external medical institutions of nursing care staff and user families. For example, when staff A was enrolled in facility X from April 2019 to March 2021 and then transferred to facility Y from April 2021, these pieces of information are recorded in chronological order. Also, when staff A took dementia care training in 2020, acquired a certified care worker qualification in 2021, and received an internal award in 2022, these pieces of information are linked. Furthermore, when user family B left a family member at facility X from 2020 to 2021, the period, staff in charge, participated family meetings, and questionnaire answer contents are also recorded. For example, when family B stated “I am anxious about the night-time monitoring system” at a family meeting in May 2020, the content is also recorded and utilized for subsequent grouping and event theme setting. The nursing care information management unit can perform API linkage with an external personnel system, nursing care recording system, shift management system, evaluation system, internal SNS, mail server, vital management system, medication management system, meal management system, electronic medical record system of an external medical institution, and the like, and automatically update information in real time. For example, when staff acquires a new qualification, the information is automatically reflected in the database. Furthermore, posting histories on the internal SNS and past exchange meeting event participation histories of the staff are also automatically imported. In addition, histories of users in charge of the staff, utterance contents at family meetings, questionnaire results, user state change records, vital data, medication/meal/rehabilitation management histories, and the like are also integrally managed, and multifaceted information of the staff and families is comprehensively retained. Specifically, the nursing care information management unit includes a data pipeline that integrally processes multimodal data. The nursing care information management unit receives time-series data of vital signs, nursing care records in text format, and image data as inputs. The nursing care information management unit inputs the time-series data into a one-dimensional convolutional neural network, and extracts a temporal feature amount. The nursing care information management unit inputs the text data into a transformer-based language model, and extracts a semantic feature vector. The nursing care information management unit combines the extracted feature amounts of the respective modalities, and generates an integrated patient state vector and staff state vector. The nursing care information management unit indexes and stores these high-dimensional vectors in a vector database. The nursing care information management unit communicates with an external electronic medical record system using a healthcare information exchange standard protocol. The nursing care information management unit automatically maps the received medical data to an internal data schema. With this configuration, the system enables comparison and search of an enormous amount of nursing care data having different formats on a single multidimensional space. The system prevents data silos and realizes comprehensive care management. The system provides an ability to instantaneously search for a past case similar to a specific symptom or care case. The nursing care information management unit automatically detects a data loss or an abnormal value using a machine learning model, and performs complementation or flagging. The nursing care information management unit continuously monitors data quality and prevents a decrease in inference accuracy of the system. The system strongly supports evidence-based decision making at a nursing care site.

Next, the group generation unit is realized on the server, and analyzes the enormous amount of information stored in the nursing care information management unit using generative AI. The generative AI operates by combining natural language processing, time-series analysis, clustering, pattern recognition, a recommendation algorithm, and the like. For example, when an administrator instructs “group staff members who were enrolled in facility X from 2020 to 2021”,

the AI extracts the staff members who were enrolled during the corresponding period, and optimizes the group by also taking into account overlaps in enrollment periods, histories of users in charge, roles, qualifications, past exchange meeting participation histories, care case sharing track records, training histories, accident/near-miss report histories, evaluations from families, and the like.

Furthermore, it can also respond to complex conditions and ambiguous instructions, such as “staff members who were enrolled together in the same facility for one year or more”, “staff members who have been in charge of the same user”, “user families who have interacted at family meetings in the past”, and “families having the same worries or problems”. For example, the AI flexibly responds to conditions such as “extract only those who have taken dementia care training among the staff members who worked at facility X from 2020 to 2021”, “group staff members who submitted accident reports of bedsore care multiple times in 2021”, and “group families who spoke about night-time monitoring at a family meeting in 2020”. The group generation unit comprehensively evaluates roles, years of experience, qualifications, past leader experiences, speech frequencies at exchange meetings, care case sharing track records, evaluations from families, the number of accident/near-miss reports, and the like, and automatically selects an optimal leader. For example, when a plurality of managerial employees such as a “chief care worker”, a “head nurse”,

and a “rehabilitation manager” exist in a group, the AI comprehensively evaluates job title hierarchies, enrollment periods, leader experiences, internal award histories, evaluations from families, and the like, and automatically determines an optimal leader. When no managerial employee exists, the AI can also automatically recommend a staff member having the longest enrollment period, a qualification holder, a staff member who played a central role in past exchange meetings, a staff member having a large track record of sharing care cases, a staff member having a high evaluation from families, or the like as a leader candidate. Specifically, the group generation unit executes an advanced clustering algorithm for skill matching and grouping of nursing care staff. The group generation unit constructs a skill vector obtained by digitizing possessed qualifications, years of experience, and past care case texts of each staff member. The group generation unit combines the skill vectors as a matrix to generate a feature tensor. The group generation unit inputs the feature tensor into an autoencoder network and compresses it into a low-dimensional latent representation. The group generation unit executes K-means clustering or hierarchical clustering in a latent representation space. The group generation unit optimizes an objective function of clustering such that staff members having skills complementing each other belong to the same group. The group generation unit outputs a clustering result of an optimized team configuration. The group generation unit executes a scoring model for evaluating leadership aptitude within each group. The scoring model receives the quality of past near-miss reports and evaluation scores from families as inputs, and outputs an aptitude score in a range of 0.0 to 1.0. The group generation unit selects a staff member having the maximum aptitude score as the leader. With this configuration, the system realizes scientific team configuration that does not depend on experience or intuition. The system prevents a bias of staff members having specific skills, and provides an optimal skill mix. The system improves the safety of care and reduces the risk of medical accidents. The group generation unit cooperates with data of a shift management system, and applies a constraint condition for preferentially grouping staff members whose actual working hours overlap. The system dynamically generates a highly effective group in line with an actual working system.

The group generation unit is capable of generating not only staff groups but also user family groups. For example, it also supports network construction among families, such as “group user families who were admitted to facility X from 2020 to 2021”, “group families who were in charge of the same user at the same time”, “group families who have interacted at family meetings in the past”, and “group families having the same worries or problems”. Furthermore, the AI also refers to questionnaire answer contents of families, speech histories at family meetings, past exchange meeting participation histories, request/complaint histories, user state change records, and the like, and proposes a group configuration that maximizes group affinity and exchange effects. For example, optimization is also possible, such as preferentially grouping families having the same worries or problems, organizing a group centering on families having a high participation rate in past exchange meetings, and setting a family who actively spoke at a family meeting as a leader. Specifically, the group generation unit executes a network construction algorithm among families. The group generation unit inputs request texts from families, complaint histories, and questionnaire answers into a natural language processing model. The natural language processing model extracts a request vector representing problems and interests of families from the text data. The group generation unit acquires a state vector indicating a user's care need level and dementia progression level. The group generation unit combines the request vector and the state vector to construct a profile tensor of each family. The group generation unit calculates a cosine similarity between the profile tensors to generate a similarity matrix among families. The group generation unit constructs a graph structure based on the similarity matrix, and applies a community detection algorithm. The group generation unit outputs a recommended group list of families having a high possibility of empathizing with each other. The group generation unit quantifies speech volumes and frequencies of positive emotional expressions at past family meetings by voice analysis and text analysis. The group generation unit identifies an optimal family member as a facilitator role of the group based on the quantified indicators. With this configuration, the system technically promotes peer support among families. The system significantly reduces the psychological burden and sense of isolation of families responsible for nursing care. The system strengthens a relationship of trust between the facility and the families. The group generation unit collects feedback from families regarding the grouping result, and continuously updates a weight parameter for similarity calculation by reinforcement learning. The system adapts to changes in family needs over time, and always provides an optimal community.

The communication support unit is realized on the server, and automatically generates and distributes, using generative AI, notifications of holding information sharing meetings and exchange meetings, participation requests, instructions for organizing the events to the leader, guidance on sharing care know-how, guidance on using an online meeting system, venue guidance, material distribution, progress schedules for the day of the event, agenda lists, FAQs, participant lists, questionnaire guidance, and the like to the grouped staff or user families and the leader using various communication means such as e-mail, an internal SNS, a chat tool, a portal site, calendar linkage, smartphone notifications, web push notifications, and voice assistant linkage. For example, the AI automatically generates a notification text such as “We will hold a care case sharing meeting among staff members who have work experience at facility X from 2020 to 2021. If you wish to participate, please register from the following link”, and transmits it to the terminal of each member. Individual instructions such as “You are requested to organize the event as a group leader. You will perform attendance confirmation of participants, agenda adjustment, material distribution, progress support by AI, and the like” are also transmitted to the leader. The notification text can also be personalized and automatically generated by the AI in accordance with attributes and past participation histories of staff and families, working styles (night shift, day shift, part-time work, remote work, etc.), residential areas of families, past exchange meeting participation statuses, request/complaint contents of families, user state change records, and the like. For example, before holding the event, the AI manages attendance statuses of participants in real time, and automatically distributes progress reports to the leader and administrators. On the day of the event, the AI cooperates with the online meeting system, and executes automatic generation of a participant list, automatic distribution of a meeting link, entry/exit management of participants, automatic display of agendas, Q&A handling by a chatbot, automatic generation of minutes, automatic saving of recorded video/audio data, automatic distribution of materials, automatic distribution of questionnaires, and the like. For example, the AI performs progress support such as “Today's agenda is ingenuity in dementia care. If you have any questions, please enter them in the chat. The AI will automatically answer”, and “Today's materials can be downloaded from the following link”. Specifically, the communication support unit executes an interactive artificial intelligence agent that understands contexts peculiar to nursing care. The communication support unit inputs text data of past care cases and attribute vectors of participants into the agent. The agent is based on a large language model, and is fine-tuned with a technical term dataset in the nursing care field. The agent generates a token sequence of a personalized information sharing message based on the input data. The communication support unit transmits the generated message to the terminal of each user as a push notification. The communication support unit executes real-time voice recognition and natural language processing during an online meeting. The communication support unit converts an audio stream of the meeting into text, and classifies intentions of utterances. The communication support unit instantaneously extracts corresponding parts of care know-how and manuals related to utterance contents using a vector search engine. The communication support unit automatically displays the extracted information on a screen as a prompt for progress support. With this configuration, the system formalizes tacit knowledge at nursing care sites, and realizes efficient sharing of know-how. The system provides knowledge of skilled staff to inexperienced staff in real time. The system standardizes the quality of care, and raises the service level of the entire facility. The communication support unit analyzes utterance ratios and emotional states of participants during the meeting, and automatically generates a facilitation message that prompts participants with few utterances to express their opinions. The system technically constructs an inclusive communication environment in which everyone can easily participate.

The event management unit supervises a series of operations related to event management, such as event planning, schedule adjustment, venue reservation, online meeting system linkage, participant management, progress management, agenda setting, material distribution, management support on the day of the event, minutes creation, recorded video/audio data management, questionnaire distribution, and follow-up after the event. For example, it has a wide variety of functions, such as the AI automatically analyzing schedules of participants and proposing an optimal holding schedule, automatically searching for venue availability and making a reservation, automatically issuing an account of an online meeting system and distributing a link, automatically generating a progress schedule and an agenda list for the day of the event, managing entry/exit of participants in real time, automatically distributing minutes and recorded data after the event ends, automatically distributing questionnaires, and automatically transmitting follow-up e-mails after the event. For example, the AI executes processes such as “analyzing calendars of all participants and automatically proposing a date and time when the largest number of people can participate”, “cooperating with a venue reservation system and automatically reserving an optimal meeting room”, “automatically issuing an account of an online meeting system and distributing a link to participants”, “automatically generating a progress schedule and an agenda list for the day of the event and distributing them to participants”, “automatically distributing minutes and recorded data after the event ends”, “automatically distributing questionnaires and automatically aggregating answers”, and “automatically transmitting follow-up e-mails after the event”. Specifically, the event management unit is executed on a server equipped with a dedicated arithmetic accelerator. The event management unit implements a large language model equipped with a schedule optimization algorithm and a self-attention mechanism. The event management unit receives calendar data of participants as an input. The input data is a binary vector indicating time-series free time. The number of dimensions of the input data is, for example, 336 dimensions indicating a one-week time frame divided into 30-minute units. As a specific example, a binary vector indicating free time of participant A, a binary vector indicating free time of participant B, and a binary vector indicating availability of a meeting room are input. The event management unit multiplies these input vectors by matrix operation. The event management unit calculates common free time of all participants. The event management unit passes the calculation result to an input layer of the large language model. The large language model outputs a probability distribution score of an optimal holding date and time. The output data is a continuous value score from 0.0 to 1.0 for each time frame. As a specific example, a score of 0.95 for a first candidate date and time, a score of 0.82 for a second candidate date and time, and a score of 0.75 for a third candidate date and time are output. The event management unit extracts a date and time whose score exceeds a preset threshold value. The event management unit transmits the extracted date and time to the user interface unit. The event management unit calls an application programming interface of the online meeting system after the date and time are finalized. The event management unit generates structured data including a meeting link. The event management unit distributes the generated link to the terminals of the participants. By this process, the system eliminates trial and error of schedule adjustment manually performed by humans. The system dramatically reduces unnecessary communication traffic between the server and the terminals. The system exhibits a technical effect of suppressing consumption of a network bandwidth. Furthermore, the event management unit automatically generates a progress schedule for the day of the event. The event management unit uses progress data of past similar events as learning data. The event management unit optimizes weights of a model using a gradient descent method. The event management unit caches the generated progress schedule on a memory. The event management unit instantaneously distributes the progress schedule in response to a request from the terminal of the participant. Thereby, the system avoids frequent access to a database. The system improves a response speed of the entire system.

The feedback analysis unit automatically analyzes feedback collected from participants after the event ends using generative AI, and performs effect measurement of the event, satisfaction evaluation, improvement point extraction, new idea extraction, proposals for subsequent events, proposals for business improvements at nursing care sites, optimization of staff education programs, proposals of support measures for user families, and the like. For example, it automatically generates questionnaires such as “care cases that were useful in this information sharing meeting”, “themes desired to be taken up in the future”, “awareness and sense of security obtained through the exchange meeting”, and “future points for improvement and new ideas”, and collects answers through the user interface unit of the terminal. The AI automatically analyzes the collected feedback, and automatically distributes quantitative and qualitative analysis results as a report to administrators and leaders, such as “satisfaction of event participants was high”, “a plurality of new care methods were shared”, “there are many voices desiring face-to-face holding next time”, “a group configuration with a large number of proposals for new care methods was a multidisciplinary mixed type”, and “strengthening of a night-time monitoring system was raised as a request from families”. The AI can also automatically propose an optimal holding time, holding format, group configuration, agenda candidates for the next event, business improvement plans at nursing care sites, optimization plans for staff education programs, proposals of support measures for user families, and the like based on past feedback histories, event participation histories, attribute information of staff and families, user state change records, and the like. Specifically, the feedback analysis unit operates on a parallel computing cluster equipped with a plurality of graphics processing units. The feedback analysis unit implements a deep learning model specialized for natural language processing. The feedback analysis unit receives free description text data of questionnaires as an input. The input data is a multidimensional word embedding vector obtained by digitizing a token sequence divided for each word. The number of dimensions of the input data is, for example, 768 dimensions. As a specific example, a vector of a text stating anxiety about night-time monitoring, a vector of a text stating that multidisciplinary cooperation was good, and a vector of a text stating a desire for face-to-face next time are input. The feedback analysis unit non-linearly transforms the input vector in a hidden layer of a neural network. The feedback analysis unit outputs an emotional polarity and a topic latent in the text. The output data is an emotion score from minus 1.0 to plus 1.0, and a one-hot vector indicating topic classification. As a specific example, a score of 0.85 indicating satisfaction, a topic label indicating business improvement, and a topic label indicating a new idea are output. The feedback analysis unit writes the output score and label into a predetermined table of a database. The feedback analysis unit aggregates scores for each topic. The feedback analysis unit automatically extracts next event theme candidates based on the aggregation result. The feedback analysis unit generates drawing data for displaying the extracted theme candidates on an administrator dashboard. By this process, the system converts a large amount of unstructured text data into structured data. The system realizes quantification of qualitative data. The system eliminates variations in evaluation due to human subjectivity. The system exhibits a technical effect of dramatically improving the accuracy of data analysis. Furthermore, the feedback analysis unit holds past feedback histories as time-series data. The feedback analysis unit predicts a time-series change trend using a recurrent neural network. The feedback analysis unit generates a business improvement plan at nursing care sites based on the prediction result. The system uses a mean square error as a loss function of a prediction model. The system continuously updates parameters of the model by a backpropagation method. Thereby, the system autonomously improves analysis accuracy over time.

The AI prompt generation unit analyzes intentions and purposes of administrators and users, past operation histories, event situations, and the like, automatically generates a prompt text for giving appropriate instructions and questions to the generative AI, and optimizes output accuracy and response quality of the AI. For example, it automatically generates specific prompt texts such as “extract staff members who were enrolled in facility X from 2020 to 2021 and group them”, “group staff members who have been in charge of the same user”, “group families who spoke about night-time monitoring at a family meeting”, “extract satisfaction, points for improvement, and new ideas from feedback of event participants and summarize them as a report”, and “analyze characteristics of this event in comparison with past feedback histories”, and inputs them to the AI. Specifically, the AI prompt generation unit includes a dedicated module that executes a reinforcement learning algorithm for prompt optimization. The AI prompt generation unit receives an input text of a user and a past operation history log as inputs. The input data is a multidimensional feature vector indicating a character code array and an operation history. The number of dimensions of the input data is, for example, 256 dimensions. As a specific example, a query character string for searching for staff of facility X, a session identifier when searching under the same conditions in the past, and numerical data indicating an authority level of the user are input. The AI prompt generation unit converts the input data into a compressed representation by an encoder network. The AI prompt generation unit generates an optimal prompt character string using a decoder network. The output data is a token array structured in a format interpretable by a large language model. As a specific example, a character string instructing to extract a list of staff members satisfying condition A and condition B, a character string specifying an output format to a specific data structure, and a system prompt character string supplementing a context of inference are output. The AI prompt generation unit directly transfers the generated prompt character string to an input layer of the large language model. The AI prompt generation unit triggers an inference process. By this process, the system converts an ambiguous instruction of the user into a strict command text that can be accurately processed by a computer. The system suppresses occurrence of malfunctions and irrelevant outputs of the large language model. The system prevents wasteful consumption of computational resources accompanying re-execution of inference. The system exhibits a technical effect of reducing a processor load of the server. Furthermore, the AI prompt generation unit accumulates a correspondence relationship between the generated prompt and an output result of the large language model in an evaluation database. The AI prompt generation unit uses validity of the output result as a reward signal. The AI prompt generation unit fine-tunes a prompt generation model using a policy gradient method of reinforcement learning. Thereby, the system acquires an ability to autonomously generate a specialized prompt specialized for a specific nursing care facility or business flow. The system continuously optimizes response quality of the entire system.

The user interface unit is realized on a terminal used by staff or user families, and provides a screen capable of intuitively operating notifications and guidance transmitted from the server, event participation registration, feedback answers, material downloads, preliminary exchanges by chat, online meeting participation on the day, questionnaire answers, FAQ references, past event history references, participant list references, family meeting speech history references, care case sharing history references, and the like. For example, using a browser of a smartphone or a personal computer, a dedicated application, or the like, detailed confirmation of an event, registration of participation availability, preliminary exchanges by chat, online meeting participation on the day, questionnaire answers, material downloads, FAQ references, past event history references, participant list references, family meeting speech history references, care case sharing history references, and the like are possible. The user interface unit can also display guidance texts and FAQs generated by the AI, past event histories, participant lists, family meeting speech histories, care case sharing histories, and the like in real time. Furthermore, the user interface unit includes a chatbot function by the AI, and can provide questions regarding events, guidance on operation methods, support for participation registration, guidance on material downloads, FAQ references, past event history references, participant list references, family meeting speech history references, care case sharing history references, and the like in real time. Specifically, the user interface unit includes a lightweight inference engine operating on an edge device. The user interface unit processes an input operation from a user in real time. The user interface unit receives touch operation coordinates and voice inputs of the user as inputs. The input data is numerical data indicating X and Y coordinates on a screen, or an acoustic feature tensor extracted from a voice waveform. The number of dimensions of the input data is, for example, in the case of voice input, 128-dimensional Mel-frequency cepstral coefficients divided in units of milliseconds. As a specific example, coordinate data indicating a specific button area on the screen, voice waveform data asking where materials are, and text data instructing to refer to past event histories are input. The user interface unit processes the input data by a neural network in the edge device. The user interface unit classifies an intention of the user. The output data is a trigger signal for screen transition, or structured data including text-converted voice data and related links. As a specific example, an identifier of a transition destination screen, a uniform resource locator indicating a storage location of materials, and an answer text of the chatbot are output. The user interface unit drives a display drawing engine of the device based on the output data. The user interface unit renders information on the screen. By this process, the system completes processing of simple inquiries and screen transitions on the edge device side. The system reduces unnecessary communication requests to a central server. The system exhibits a technical effect of preventing network congestion. Furthermore, the user interface unit performs asynchronous communication with the large language model on the server side. The user interface unit delegates processing to the server only for complex questions. The user interface unit performs temporary screen display using a local cache until receiving a response from the server. Thereby, the system provides smooth operability that does not make the user feel communication delay. The system maximizes response performance of a human-machine interface.

As described above, in the embodiment of the present invention, by realizing the nursing care information management unit, the group generation unit, the communication support unit, the event management unit, the feedback analysis unit, and the AI prompt generation unit on the server, and realizing the user interface unit on the terminal, an automated and streamlined information sharing and exchange support system at nursing care sites with generative AI as a core is provided, which becomes an extremely useful system contributing to sustainable growth and service quality improvement at nursing care sites, such as reconstruction of bonds among staff and families, strengthening of cross-site cooperative relationships, improvement of overall care quality and satisfaction, business improvements, optimization of staff education programs, proposals of support measures for user families, rapid responses to user state changes, prevention of recurrence of accidents and near-misses, and strengthening of cooperation with external medical institutions. Specifically, the system adopts a distributed computing architecture in which a plurality of computing nodes are connected by a high-speed internal bus. In the system, each unit operates by being containerized as an independent microservice. The system asynchronously transmits and receives data among the respective units via a message queuing system. The system arranges normalized data output from the nursing care information management unit in a shared memory space. In the system, the group generation unit reads data from the shared memory space, and executes a clustering operation in a high-dimensional space. In the system, the communication support unit and the event management unit receive a clustering result, and perform notification generation and schedule optimization by parallel processing. In the system, the feedback analysis unit collectively analyzes text data collected after the event ends by batch processing. In the system, the AI prompt generation unit monitors processing statuses of the respective units, and dynamically optimizes prompts. In the system, the user interface unit integrates these processing results and displays them on the terminal. By this series of data flows, the system prevents a load from concentrating on a single processor. The system exhibits a technical effect of maximizing throughput of the entire system. Furthermore, the system has a loop structure that mutually feeds back inference results of artificial intelligence models used in the respective units. The system reuses, for example, an output result of the feedback analysis unit as learning data of the group generation unit. The system improves the accuracy of next grouping. Thereby, the system realizes a self-evolving information processing mechanism in which intelligence of the entire system improves as data is accumulated, not limited to mere automation of business. The system quantitatively models complex human relationships and tacit knowledge at nursing care sites on a computer. The system enables advanced information sharing and exchange support that were impossible with conventional methods.

### System Configuration

The system according to the present embodiment includes a nursing care information management unit, a group generation unit, a communication support unit, an event management unit, a feedback analysis unit, an AI prompt generation unit, and a user interface unit. The nursing care information management unit is a unit that centrally stores and manages, as a database, all nursing care-related information such as names, IDs, roles (nursing care staff, nurses, rehabilitation staff, registered dietitians, user families, etc.), affiliated facilities, assignment start dates and end dates, contact information, transfer histories, histories of users in charge, past exchange meeting participation histories, care case information, qualification information, evaluation information, questionnaire results, shift information, training histories, accident/near-miss report histories, exchange histories on an internal SNS, family meeting participation histories, request/complaint histories from families, user state change records, vital data, medication management histories, meal management histories, rehabilitation plan histories, and cooperation histories with external medical institutions of nursing care staff and user families in nursing care facilities and home nursing care service offices. For example, when staff member A was enrolled in facility X from April 2019 to March 2021, and then transferred to facility Y from April 2021, this information is recorded in chronological order. Also, when staff member A took dementia care training in 2020, acquired a certified care worker qualification in 2021, and received an internal award in 2022, this information is also linked. Furthermore, when user family B entrusted a family member to facility X from 2020 to 2021, the period, staff in charge, participated family meetings, and questionnaire answer contents are also recorded. For example, when family B spoke “I have anxiety about a night-time monitoring system” at a family meeting in May 2020, the content is also recorded and utilized for subsequent grouping and event theme setting. The nursing care information management unit can perform API linkage with external personnel systems, nursing care recording systems, shift management systems, evaluation systems, internal SNSs, e-mail servers, vital management systems, medication management systems, meal management systems, electronic medical record systems of external medical institutions, and the like, and automatically update information in real time. For example, when a staff member acquires a new qualification, the information is automatically reflected in the database. Furthermore, posting histories of staff on the internal SNS and past exchange meeting event participation histories are also automatically imported. In addition, histories of users in charge of staff, speech contents at family meetings, questionnaire results, user state change records, vital data, medication/meal/rehabilitation management histories, and the like are also integratedly managed, and multifaceted information of staff and families is comprehensively held. Specifically, the nursing care information management unit adopts a hybrid configuration of a graph database and a relational database constructed on a storage server equipped with a large-capacity solid state drive. The nursing care information management unit receives raw data from external systems and various sensors as inputs. The input data is a set of unstructured data and structured data having different formats. The number of dimensions and formats of the input data are diverse. As a specific example, time-series tensor data of heart rates and blood pressures transmitted from vital sensors, text log data extracted from electronic medical record systems, and numerical array data of working hours acquired from shift management systems are input. The nursing care information management unit executes preprocessing of noise removal, missing value imputation, and normalization on the input data. The nursing care information management unit converts the preprocessed data into a multidimensional feature vector. The output data is a fixed-length feature vector representing attributes and histories of each staff member and user family. As a specific example, a 512-dimensional vector representing a skill set of a staff member, a 256-dimensional vector indicating a request tendency of a family, and a time-series feature vector indicating a user state change are output. The nursing care information management unit maps the output feature vector to an index space of the database. The nursing care information management unit constructs an approximate nearest neighbor search index for speeding up similarity search between vectors. By this process, the system manages an enormous amount of heterogeneous data in a unified vector space. The system dramatically reduces a calculation order of data search and extraction processing in the subsequent group generation unit. The system exhibits a technical effect of shortening a query response time of the database to a millisecond unit. Furthermore, the nursing care information management unit performs storage tiering in accordance with an update frequency of data. The nursing care information management unit arranges frequently accessed latest data in a high-speed volatile memory. The nursing care information management unit saves past history data to an inexpensive non-volatile storage. Thereby, the system utilizes limited hardware resources efficiently to the utmost limit. The system reduces an operation cost of the entire system.

The group generation unit is a unit that analyzes the enormous amount of information stored in the nursing care information management unit using generative AI, automatically extracts staff members or user families having commonalities or relevance based on conditions such as a specified period, facility, role, qualification, user in charge, contents of remarks at family meetings, questionnaire answer contents, accident/near-miss report histories, track records of sharing care cases, evaluations from families, and records of changes in user conditions, and groups the extracted persons. For example, it flexibly responds to complex conditions and ambiguous instructions such as “group staff members who were enrolled in facility X from 2020 to 2021”, “group staff members who have been in charge of the same user”, “group families who spoke about nighttime monitoring at a family meeting”, “group staff members who have taken dementia care training”, “group staff members who have submitted accident reports of bedsore care a plurality of times”, and “group families having the same worries or issues”. The group generation unit comprehensively evaluates roles, years of experience, qualifications, past leader experiences, frequencies of remarks at exchange meetings, track records of sharing care cases, evaluations from families, the number of accident/near-miss reports, and the like, and automatically selects an optimal leader. For example, when a plurality of managerial employees such as a “nursing care chief”, a “head nurse”, and a “rehabilitation manager” exist in a group, the AI comprehensively evaluates job title hierarchies, enrollment periods, leader experiences, internal award histories, evaluations from families, and the like, and automatically determines an optimal leader. When no managerial employee exists, the AI can also automatically recommend a staff member having the longest enrollment period, a qualification holder, a staff member who played a central role in past exchange meetings, a staff member having a large track record of sharing care cases, a staff member highly evaluated by families, or the like as a leader candidate. Examples of prompt sentences to be read by the generative AI include “extract staff members who were enrolled in facility X from 2020 to 2021 and group them”, “group staff members who have been in charge of the same user”, and “group families who spoke about nighttime monitoring at a family meeting”. Specifically, the group generation unit implements a graph neural network and a density-based spatial clustering algorithm executed on a dedicated processor specialized for tensor operations. The group generation unit receives, as inputs, a feature vector extracted from the nursing care information management unit and an adjacency matrix indicating relationships. The input data is an attribute vector of staff members or families as nodes, and a weighted matrix indicating past collaboration histories and exchange frequencies as edges. The number of dimensions of the input data is an N-by-N matrix and an N-by-M feature tensor corresponding to the number of target personnel. As a specific example, numerical data indicating the number of times staff A and staff B worked in the same shift, a cosine similarity score indicating the similarity of contents of remarks at family meetings, and a binary flag indicating the commonality of accident report histories are input. The group generation unit propagates the input data across a plurality of layers of the graph neural network. The group generation unit learns potential relationships between the nodes. The group generation unit executes clustering using the learned representations. The output data is an identifier array of a cluster to which each node belongs, and an array of floating-point numbers indicating a leader score of each node. As a specific example, an integer value of 3 as the cluster identifier, 0.92 as the leader score, and a betweenness centrality score indicating centrality within the group are output. The group generation unit sets a node having the maximum leader score as the leader of the group. The group generation unit writes group configuration data into a shared memory. By this process, the system instantaneously calculates complex relationships in a high-dimensional space that cannot be visually confirmed by a human. The system realizes optimal grouping based on potential affinity rather than mere condition matching. The system exhibits a technical effect of significantly reducing calculation time required for group organization. Furthermore, the group generation unit detects a node that becomes an outlier during clustering. The group generation unit identifies staff members or families who tend to be isolated. The group generation unit incorporates a penalty function for forcibly assigning those nodes to an appropriate group into a loss function. Thereby, the system corrects communication bias in the entire organization. The system constructs a comprehensive information sharing network.

The communication support unit is a unit that automatically generates and distributes notifications of holding information sharing meetings and exchange meetings, participation requests, instructions for organizing the events to the leader, guidance on sharing care know-how, guidance on using an online meeting system, venue guidance, material distribution, progress schedules on the day of the event, agenda lists, FAQs, participant lists, questionnaire guidance, and the like to the grouped staff or user families and the leader utilizing generative AI, using various communication means such as e-mail, an internal SNS, a chat tool, a portal site, calendar linkage, smartphone notifications, web push notifications, and voice assistant linkage. For example, the AI automatically generates a notification text such as “We will hold a care case sharing meeting among staff members who have work experience at facility X from 2020 to 2021. If you wish to participate, please register from the link below”, and transmits it to the terminal of each member. Individual instructions such as “You are requested to organize the event as a group leader. You will perform attendance confirmation of participants, agenda adjustment, material distribution, progress support by AI, and the like” are also transmitted to the leader. The notification text can also be personalized and automatically generated by the AI according to attributes and past participation histories of staff members and families, work styles and residential areas of families, past exchange meeting participation statuses, contents of requests/complaints from families, records of changes in user conditions, and the like. Examples of prompt sentences to be read by the generative AI include “generate an event guidance text for the grouped staff members, and create an individual instruction text including an organization request for the leader” and “personalize the guidance text according to the work styles and past participation histories of the participants”. Specifically, the communication support unit implements a deep learning model equipped with a self-attention mechanism specialized for natural language generation. The communication support unit receives, as inputs, the group configuration data and the user attribute vector output from the group generation unit. The input data is an identifier list of group members, a flag array indicating a desired communication means of each member, and numerical data indicating past message open rates. The number of dimensions of the input data is variable-length array data corresponding to the number of members. As a specific example, categorical data indicating a language setting of a user, flag data prioritizing push notifications to a smartphone, and timestamp data instructing a transmission delay for a staff member after a night shift are input. The communication support unit supplies the input data to an encoder of the natural language generation model. The communication support unit generates a personalized message text using a decoder. The output data is a text string of a message optimized for each user, and structured data indicating a distribution schedule. As a specific example, an e-mail body decorated in a hypertext markup language format, a short text payload for push notifications, and a UNIX timestamp indicating a scheduled transmission time are output. The communication support unit registers the output structured data as a job in a message queuing system. The communication support unit executes transmission processing asynchronously according to the specified timestamp. By this process, the system completely automates personalized message generation for staff members and families on a scale of thousands of people. The system levels out load spikes on a central processing unit of the server. The system exhibits a technical effect of preventing message distribution delays and losses. Furthermore, the communication support unit tracks message open statuses and link click histories after transmission in real time. The communication support unit utilizes the tracking data for reinforcement learning of the natural language generation model through a feedback loop. Thereby, the system autonomously learns configurations of subjects and bodies that maximize user response rates. The system continuously improves the certainty of information transmission.

The event management unit is a unit that supervises a series of operations related to event management, such as event planning, schedule adjustment, venue reservation, online meeting system linkage, participant management, progress management, agenda setting, material distribution, management support on the day of the event, minutes creation, recording/audio data management, questionnaire distribution, and follow-up after the event. For example, it has a wide variety of functions, such as the AI automatically analyzing participants' schedules and proposing an optimal holding schedule, automatically searching for venue availability and making a reservation, automatically issuing an account for an online meeting system and distributing a link, automatically generating a progress schedule and an agenda list on the day of the event, managing entry and exit of participants in real time, automatically distributing minutes and recording data after the event ends, automatically distributing a questionnaire, and automatically transmitting a follow-up e-mail after the event. Examples of prompt sentences to be read by the generative AI include “analyze the calendars of all participants and propose a date and time when the largest number of people can participate”, “automatically generate an event progress schedule and an agenda list”, and “issue a link for an online meeting system and distribute it to the participants”. Specifically, the event management unit includes an arithmetic module that implements a constraint satisfaction problem solving algorithm and a schedule optimization model. The event management unit receives, as inputs, calendar data of prospective participants and venue availability data. The input data is a multidimensional binary tensor in which time is divided at regular intervals. The number of dimensions of the input data is, for example, a tensor in which 2880-dimensional vectors indicating time frames for one month divided into 15-minute units are bundled for the number of participants. As a specific example, a logical product vector indicating a time zone in which all participants are commonly available, a reservable flag array of a specific meeting room, and numerical data indicating an upper limit of simultaneous connections of the online meeting system are input. The event management unit executes a matrix operation on the input tensor. The event management unit searches for an optimal holding date and time satisfying all constraint conditions. The output data is structured data including a timestamp of the optimal holding date and time, an identifier of the secured meeting room, and a uniform resource locator for connection of the online meeting. As a specific example, a timestamp string indicating a start time, an alphanumeric string indicating a meeting room identifier, and an automatically generated meeting password are output. The event management unit calls a calendar application programming interface using the output timestamp. The event management unit automatically writes the event into the schedules of the participants. By this process, the system eliminates an enormous number of communications and waiting times associated with schedule adjustments among a plurality of persons. The system optimizes network traffic. The system exhibits a technical effect of shortening a lead time from event planning to holding to the utmost limit. Furthermore, in the progress management on the day of the event, the event management unit measures speaking times of the participants in real time using a voice recognition model. The event management unit compares the progress status of the scheduled agenda with the actual elapsed time. The event management unit automatically transmits an alert prompting progress to the terminal of the leader when a delay occurs. Thereby, the system forcibly ensures efficient information sharing within a limited time. The system improves meeting productivity at a hardware level.

The feedback analysis unit is a unit that automatically analyzes feedback collected from participants after the event ends using generative AI, and performs event effect measurement, satisfaction evaluation, improvement point extraction, new idea extraction, proposals for subsequent events, business improvement proposals at nursing care sites, optimization of staff education programs, proposals of family support measures, and the like. For example, it automatically generates a questionnaire such as “care cases that were useful in this information sharing meeting”, “themes you want to be taken up in the future”, “realizations and sense of security obtained through the exchange meeting”, and “future points for improvement and new ideas”, and collects answers through the user interface unit of the terminal. The AI automatically analyzes the collected feedback, and automatically distributes quantitative and qualitative analysis results, such as “satisfaction of event participants was high”, “a plurality of new care methods were shared”, “there are many voices desiring face-to-face holding next time”, “the group configuration with a large number of proposals for new care methods was a multidisciplinary mixed type”, and “strengthening of the nighttime monitoring system was raised as a request from families”, to administrators and leaders as a report. Examples of prompt sentences to be read by the generative AI include “extract satisfaction, points for improvement, and new ideas from the feedback of the event participants and summarize them as a report” and “compare with past feedback histories and analyze the characteristics of this event”. Specifically, the feedback analysis unit implements topic modeling based on latent Dirichlet allocation and a deep learning-based sentiment analysis neural network. The feedback analysis unit receives, as an input, a text corpus of the collected questionnaire answers. The input data is a document-term matrix indicating word appearance frequencies, or a high-dimensional sentence embedding vector converted by a pre-trained language model. The number of dimensions of the input data is a sparse matrix of tens of thousands of dimensions depending on the vocabulary size, or a 768-dimensional dense vector. As a specific example, a vector of free description text regarding useful care cases, a vector of text regarding points for improvement, and numerical data of a five-point scale evaluation are input. The feedback analysis unit subjects the input vector to forward propagation processing of the neural network. The feedback analysis unit calculates a potential topic distribution and sentiment polarity hidden in the text. The output data is a probability distribution array indicating an applicable probability of each topic, and a continuous value score indicating sentiment polarity. As a specific example, a probability of 0.75 for a business improvement topic, a positive sentiment score of 0.88, and a negative sentiment score of 0.12 are output. The feedback analysis unit extracts important feedback in which the calculated score exceeds a preset threshold. The feedback analysis unit writes the extracted data into a database of an administrator dashboard. By this process, the system instantaneously summarizes a large amount of text data that is difficult for a human to read manually, and converts it into quantitative indicators. The system compresses information entropy of the text data. The system exhibits technical effects of saving storage capacity and improving search speed. Furthermore, the feedback analysis unit calculates differences between the extracted new ideas or points for improvement and past similar cases. The feedback analysis unit determines whether or not it is a completely new proposal. The feedback analysis unit assigns a high priority flag to a proposal determined to have high novelty. Thereby, the system automatically picks up important information directly linked to innovation at nursing care sites without burying it. The system accelerates a knowledge creation process of the organization.

The AI prompt generation unit is a unit that analyzes intentions and purposes of administrators and users, past operation histories, event situations, and the like, automatically generates prompt sentences for giving appropriate instructions and questions to the generative AI, and optimizes output accuracy and response quality of the AI. For example, it automatically generates specific prompt sentences such as “extract staff members who were enrolled in facility X from 2020 to 2021 and group them”, “group staff members who have been in charge of the same user”, “group families who spoke about nighttime monitoring at a family meeting”, “extract satisfaction, points for improvement, and new ideas from the feedback of the event participants and summarize them as a report”, and “compare with past feedback histories and analyze the characteristics of this event”, and inputs them to the AI. Specifically, the AI prompt generation unit implements a dedicated neural network equipped with an encoder and decoder architecture for automating prompt engineering. The AI prompt generation unit receives, as inputs, natural language queries of administrators and users and a context information vector. The input data is a raw text string input by the user, and a multidimensional vector indicating a past operation history based on a session identifier. The number of dimensions of the input data is, for example, a variable-length array depending on the maximum number of tokens of the text and a 128-dimensional context vector. As a specific example, a query string to extract staff members who were enrolled in a specific facility, a vector indicating similar search conditions executed in the past, and numerical data indicating a current system load status are input. The AI prompt generation unit converts the input data into a representation in a latent space by the encoder. The AI prompt generation unit generates a structured prompt string to which a large language model can respond with the highest accuracy using the decoder. The output data is string data combining a system prompt, a user prompt, and a specification constraint of an output format. As a specific example, a system prompt string defining a role, a user prompt string enumerating specific extraction conditions, and a format specification string instructing to output a result in a specific data structure are output. The AI prompt generation unit transmits the generated prompt string to an endpoint of an application programming interface of an inference engine. By this process, the system absorbs input fluctuations and ambiguities of the user. The system always normalizes input data to the inference engine into an optimal format. The system dramatically reduces an error rate of the inference engine. The system exhibits technical effects of reducing retry processing associated with errors and saving calculation resources. Furthermore, the AI prompt generation unit monitors whether or not parsing processing of an output result of the inference engine has succeeded. The AI prompt generation unit includes a self-healing function of changing constraint conditions of the prompt more strictly and regenerating it when parsing fails. Thereby, the system continues to operate robustly even against version upgrades and behavior changes of external artificial intelligence models.

The user interface unit is a unit realized on a terminal used by staff members or user families, and provides a screen capable of intuitively operating notifications and guidance transmitted from the server, event participation registration, feedback answers, material downloads, preliminary exchanges via chat, online meeting participation on the day, questionnaire answers, FAQ references, past event history references, participant list references, family meeting remark history references, care case sharing history references, and the like. For example, using a browser of a smartphone or a personal computer, a dedicated application, or the like, detailed confirmation of events, registration of participation availability, preliminary exchanges via chat, online meeting participation on the day, questionnaire answers, material downloads, FAQ references, past event history references, participant list references, family meeting remark history references, care case sharing history references, and the like are possible. The user interface unit can also display guidance texts and FAQs generated by the AI, past event histories, participant lists, family meeting remark histories, care case sharing histories, and the like in real time. Furthermore, the user interface unit includes a chatbot function by AI, and can provide questions regarding events, guidance on operation methods, support for participation registration, guidance on material downloads, FAQ references, past event history references, participant list references, family meeting remark history references, care case sharing history references, and the like in real time. Specifically, the user interface unit includes a lightweight inference model executed directly on a processor of an edge device such as a smartphone or a tablet. The user interface unit processes various input modalities from the user in real time. The user interface unit receives, as inputs, touch operation coordinates of the user, swipe trajectory data, and acoustic features of voice input. The input data is a time-series array of X coordinates and Y coordinates on a screen, and a tensor of Mel-frequency cepstral coefficients extracted from a voice waveform. The number of dimensions of the input data is, for example, a 256-dimensional feature matrix converted from voice data with a sampling rate of 16 kilohertz. As a specific example, coordinate data indicating an area of a participation registration button, trajectory data for scrolling the screen, and voice waveform data saying “show me past histories” are input. The user interface unit processes the input data by a neural network in the edge device. The user interface unit immediately classifies the user's intention. The output data is a trigger signal for screen transition, textified voice data, and structured data for drawing update. As a specific example, an identifier of a transition destination screen, a recognized text string, and fragment data of a hypertext markup language for displaying an answer of the chatbot are output. The user interface unit drives a graphics processing unit of the device based on the output data. The user interface unit executes redrawing processing of the screen. By this process, the system completes feedback to the user's operation on the edge side. The system eliminates a round-trip time due to communication with the server. The system exhibits a technical effect of minimizing operation delays. Furthermore, the user interface unit caches large-capacity material data and past event history data received from the server in a local non-volatile memory. The user interface unit continues to provide some functions even in an offline environment. Thereby, the system supports information references and preliminary exchanges without interruption even at nursing care sites where communication environments are unstable.

### Implementation Steps

Step 1: Collection and Integration of Nursing Care-Related Data The nursing care information management unit centrally collects and integrates, as a database, a wide variety of nursing care-related information such as names, IDs, roles, affiliated facilities, assignment start dates and end dates, contact information, transfer histories, histories of users in charge, past exchange meeting participation histories, care case information, qualification information, evaluation information, questionnaire results, shift information, training histories, accident/near-miss report histories, exchange histories on an internal SNS, family meeting participation histories, histories of requests/complaints from families, records of changes in user conditions, vital data, medication management histories, meal management histories, rehabilitation plan histories, and linkage histories with external medical institutions of nursing care staff and user families, and automatically updates the information in real time by API linkage with external systems and various recording systems. Specifically, in Step 1, the nursing care information management unit executes a hybrid data pipeline combining batch processing and streaming processing. The nursing care information management unit receives a data payload as an input via an application programming interface call from an external system. The input data is a set of unstructured data and structured data described in a JSON format. The number of dimensions and the number of elements of the input data dynamically change depending on a transmission source system. As a specific example, time-series array data of heart rates transmitted in real time from a vital sensor, numerical data of working hours transmitted daily from a shift management system, and text data extracted from an electronic medical record are input. The nursing care information management unit executes schema verification and data cleansing on the input data. The nursing care information management unit performs complementation of missing values and removal of abnormal values. The nursing care information management unit converts the cleansed data into normalized database records. The output data is row data insertable into a table of a relational database, and structured data configuring nodes and edges of a graph database. As a specific example, row data including basic information of staff members, categorical data indicating qualification information, and edge data indicating relationships between staff members are output. The nursing care information management unit writes the output data into the database, and simultaneously reconstructs an index for search in the background. By this process, the system consistently integrates information from a wide variety of data sources. The system guarantees data consistency at a hardware level. The system exhibits a technical effect of speeding up transactions in subsequent search processing and analysis processing. Furthermore, the nursing care information management unit retains all data update histories as transaction logs. The nursing care information management unit supports a time travel query that restores a data state at an arbitrary past point in time. Thereby, the system accurately reproduces a state of the organization at a specific time in the past, enabling more precise grouping and analysis.

Step 2: Setting of Grouping Conditions and AI Prompt Generation An administrator or the system specifies grouping conditions (e.g., staff members who were enrolled in facility X from 2020 to 2021, staff members who have been in charge of the same user, staff members who have taken dementia care training, families who spoke about nighttime monitoring at a family meeting, etc.), and the AI prompt generation unit automatically generates prompt sentences for instructing the generative AI based on these conditions. Examples of prompt sentences to be read by the generative AI include “extract staff members who were enrolled in facility X from 2020 to 2021 and group them”, “group staff members who have been in charge of the same user”, and “group families who spoke about nighttime monitoring at a family meeting”. Specifically, in Step 2, the AI prompt generation unit executes a prompt generation algorithm triggered by an input operation from the administrator. The AI prompt generation unit receives, as inputs, condition parameters set by the administrator through the user interface unit. The input data is an associative array data structure consisting of key-value pairs. The number of dimensions of the input data is variable-length depending on the number of set conditions. As a specific example, data having a facility as a key and X as a value, data having a period as a key and 2020 to 2021 as a value, and data having training as a key and dementia care as a value are input. The AI prompt generation unit analyzes the input associative array data. The AI prompt generation unit constructs a natural language prompt string using an internally held template engine or language generation model. The output data is text string data optimized into a format interpretable by the generative artificial intelligence. As a specific example, a string to extract staff members who were enrolled in facility X from 2020 to 2021, a string to identify staff members having a history of being in charge of the same user, and a constraint string to return an output result in a specific data structure are output. The AI prompt generation unit writes the generated prompt string into a shared area on a memory. The AI prompt generation unit hands over the processing to the subsequent group generation unit. By this process, the system enables even an administrator without knowledge of complex database query languages to specify advanced data extraction conditions with intuitive operations. The system reduces an operation burden on the user by abstracting condition specifications. The system exhibits a technical effect of eliminating human input errors by automating query generation. Furthermore, the AI prompt generation unit stores patterns of prompts that succeeded in the past in a cache memory. The AI prompt generation unit immediately reads out a prompt from the cache and reuses it when similar conditions are input. Thereby, the system shortens calculation time required for prompt generation and improves responsiveness of the entire system.

Step 3: Grouping and Leader Selection by Generative AI The group generation unit analyzes the database of the nursing care information management unit using the generative AI, extracts staff members or user families corresponding to the specified conditions, and executes grouping. Furthermore, it comprehensively evaluates roles, years of experience, qualifications, past leader experiences, track records of sharing care cases, evaluations from families, and the like from within the group, and automatically selects an optimal leader. Examples of prompt sentences to be read by the generative AI include “select an optimal leader from among the grouped staff members in consideration of job titles, years of experience, qualifications, track records of sharing care cases, and evaluations from families”. Specifically, in Step 3, the group generation unit executes a deep learning-based clustering model and a feature extraction network. The group generation unit receives, as inputs, the prompt string handed over from the AI prompt generation unit and the feature matrix extracted from the nursing care information management unit. The input data is text string data and a multidimensional tensor in which attributes of target staff members or families are digitized. The number of dimensions of the input data is, for example, a 512-dimensional feature matrix for 100 target persons. As a specific example, a prompt string indicating extraction conditions, a numerical vector in which years of experience and qualifications of staff members are normalized, and a score array indicating past track records of sharing care cases are input. The group generation unit processes the input data in a hidden layer of the neural network. The group generation unit calculates distances between respective nodes in a high-dimensional space, and executes clustering. The output data is an array of cluster identifiers to which respective target persons are assigned, and an array of floating-point numbers indicating leader scores of the respective target persons. As a specific example, an integer array indicating affiliated groups of the respective target persons such as 1, 1, 2, 1, and a score array indicating aptitudes as a leader such as 0.5, 0.9, 0.2 are output. The group generation unit identifies an index having a maximum value in the score array. The group generation unit sets a leader flag for the corresponding target person and updates a record of the database. By this process, the system automates grouping and leader selection based on potential aptitudes in which a plurality of variables are complexly intertwined, which is impossible with a simple rule base. The system realizes highly accurate matching based on multidimensional data. The system exhibits a technical effect of shortening an enormous calculation time when manually performed by a human to a millisecond unit. Furthermore, the group generation unit refers to past performance data of the selected leader. The group generation unit includes a load balancing function of adding a penalty term to the score and recalculating it so that the burden on the leader is not excessively concentrated. Thereby, the system supports sustainable operation of the entire organization.

### Step 4: Automatic Generation and Distribution of Event Notifications and Guidance

The communication support unit automatically generates and distributes, using generative AI, notifications of holding information sharing meetings and exchange meetings, participation requests, instructions for organizing the events to the leader, guidance on sharing care know-how, guidance on using an online meeting system, venue guidance, material distribution, a schedule for the day of the event, an agenda list, an FAQ, a participant list, questionnaire guidance, and the like to the grouped staff or user families and the leader using various communication means such as e-mail, an internal SNS, a chat tool, a portal site, calendar linkage, smartphone notifications, web push notifications, and voice assistant linkage. Examples of prompt sentences to be read by the generative AI include “Generate an event guidance text for the grouped staff, and create an individual instruction text including a request for organizing for the leader” and “Personalize the guidance text according to the working styles and past participation histories of the participants”. Specifically, in this Step 4, the communication support unit executes a text generation model and a multi-channel distribution control algorithm. The communication support unit receives group information, a leader flag, and user attribute data output from the group generation unit as inputs. The input data is a list of identifiers of group members, a binary flag indicating the leader, and categorical data indicating a device type and language settings of each user. The number of dimensions of the input data is variable-length structured data corresponding to the number of distribution targets. As a specific example, an e-mail address character string of a participant, a device token character string of a smartphone application, and numerical data indicating a past event participation history are input. The communication support unit supplies the input data to the text generation model. The communication support unit generates a guidance text personalized to the attributes of each user. The output data is payload data optimized for the screen size and notification format of the device. As a specific example, body text data in a hypertext markup language format for e-mail, a short text character string for push notifications, and a data structure in a JSON format including instructions for organizing dedicated to the leader are output. The communication support unit transmits the output payload data to a push notification server or a mail transfer agent. The communication support unit completes the distribution process asynchronously. By this process, the system integrally controls various communication means. The system automatically selects a channel that is easiest for each user to check and transmits information. The system realizes optimization of multi-channel distribution. The system exhibits technical effects of efficient use of network bandwidth and a dramatic improvement in the distribution success rate. Furthermore, the communication support unit includes a fallback mechanism that automatically switches to an alternative channel and retransmits in preparation for a case where a distribution error occurs. Thereby, the system guarantees at a hardware level that important event notifications reliably reach all targets.

### Step 5: Event Management and Progress Support

The event management unit supervises event planning, schedule adjustment, venue reservation, online meeting system linkage, participant management, progress management, agenda setting, material distribution, management support on the day of the event, minutes creation, recording/audio data management, questionnaire distribution, follow-up after the event, and the like, and the generative AI performs a wide variety of management support such as automatically analyzing schedules of participants and proposing an optimal holding schedule, automatically searching for and reserving venue availability, automatically issuing an account for an online meeting system and distributing a link, automatically generating a schedule and an agenda list for the day of the event, managing entry and exit of participants in real time, automatically distributing minutes and recorded data after the event ends, automatically distributing a questionnaire, and automatically transmitting a follow-up e-mail after the event. Examples of prompt sentences to be read by the generative AI include “Analyze the calendars of all participants and propose a date and time when the largest number of people can participate”, “Automatically generate an event schedule and an agenda list”, and “Issue a link for the online meeting system and distribute it to the participants”. Specifically, in this Step 5, the event management unit executes a schedule optimization algorithm and an application programming interface control module for external system linkage. The event management unit receives calendar data of prospective participants and venue availability data as inputs. The input data is a multidimensional binary tensor in which time is divided at regular intervals. The number of dimensions of the input data is, for example, a tensor in which vectors indicating time frames divided in units of 15 minutes are bundled for the number of participants. As a specific example, a list of free time blocks of participants, data indicating reservable time zones of conference rooms, and numerical data indicating license availability of the online meeting system are input. The event management unit executes a matrix operation for solving a constraint satisfaction problem on the input tensor. The event management unit calculates an optimal holding date and time. The output data is structured data including a timestamp of the optimal date and time, an identifier of a secured conference room, and a uniform resource locator for connection of the online meeting. As a specific example, a UNIX timestamp indicating a start time, an alphanumeric string indicating a conference room identifier, and an automatically generated password for the meeting are output. The event management unit calls interfaces of the meeting system and the calendar system using the output timestamp. The event management unit automatically completes securing of the schedule and issuing of the link. By this process, the system completely eliminates an enormous number of communications and waiting times associated with schedule adjustments among a plurality of people. The system realizes a reduction in processing time by automating schedule adjustments. The system exhibits technical effects of minimizing the number of interface calls to external systems and reducing a communication load. Furthermore, the event management unit automatically generates a schedule and an agenda list for the day of the event using generative AI. The event management unit generates a download link for distributing the generated materials to terminals of the participants in advance. Thereby, the system seamlessly integrates a series of processes from preparation for the event to management on the day, and dramatically reduces management costs.

### Step 6: Event Participation, Exchange, and Real-Time AI Support

Through the user interface unit, staff and user families perform detailed confirmation of the event, registration of participation availability, preliminary exchange via chat, participation in the online meeting on the day, questionnaire answering, material downloading, FAQ reference, past event history reference, participant list reference, family meeting remark history reference, care case sharing history reference, and the like. During the event, the generative AI performs support such as creating minutes in real time, immediately answering questions from participants as a chatbot, and immediately presenting past collaboration histories and project materials. Examples of prompt sentences to be read by the generative AI include “Summarize remarks during the event as minutes in real time”, “Automatically answer questions from participants by referring to an FAQ database”, and “Present related materials based on past collaboration histories”. Specifically, in this Step 6, the user interface unit executes an inference engine integrating a real-time speech recognition model and a natural language processing model. The user interface unit receives audio stream data during the event and text input from a user as inputs. The input data is audio waveform data in a pulse code modulation format and a character code array input into a chat box. The number of dimensions of the input data is a one-dimensional audio waveform array continuously input at a sampling rate of 16 kilohertz and a variable-length text vector. As a specific example, audio waveform data indicating a remark during a meeting, text data saying “I will check the material”, and a query character string for searching past collaboration histories are input. The user interface unit processes the input audio data with the speech recognition model. The user interface unit converts speech into text. The output data is structured data including a textualized remark record provided with a timestamp and answer text from the chatbot. As a specific example, a remark text character string provided with a timestamp of 10:05:30, answer text to a question, and a download link for related materials are output. The user interface unit superimposes and displays the output text data as subtitles on a screen in real time. The user interface unit simultaneously saves the data in a database of a server. By this process, the system instantaneously visualizes remarks during the meeting and improves accessibility for hearing-impaired persons and users in poor communication environments. The system realizes minimization of delay by real-time processing. The system exhibits a technical effect of completely eliminating human labor required for creating meeting records. Furthermore, the user interface unit extracts important keywords from remark contents in real time. The user interface unit automatically searches for past care cases and project materials related to the keywords and presents them on a sidebar of the screen. Thereby, the system supports advanced knowledge sharing independent of participants' memories in parallel with the progress of the meeting.

### Step 7: Feedback Collection, Analysis, and Reporting

After the event ends, the feedback analysis unit transmits a feedback request to all participants using generative AI, automatically generates a questionnaire such as “care cases that were useful in this information sharing meeting”, “themes desired to be taken up in the future”, “realizations and sense of security obtained through the exchange meeting”, and “future points for improvement and new ideas”, and collects answers through the user interface unit of the terminal. The AI automatically analyzes the collected feedback and automatically distributes quantitative and qualitative analysis results to administrators and leaders as a report, such as “satisfaction of event participants was high”, “a plurality of new care methods were shared”, “there are many voices desiring face-to-face holding next time”, “a group configuration with a large number of proposals for new care methods was a multidisciplinary mixed type”, and “strengthening of a nighttime monitoring system was raised as a request from families”. Examples of prompt sentences to be read by the generative AI include “Extract satisfaction, points for improvement, and new ideas from feedback of event participants and summarize them as a report” and “Analyze characteristics of this event in comparison with past feedback histories”. Specifically, in this Step 7, the feedback analysis unit executes a deep learning model for sentiment analysis and summary generation. The feedback analysis unit receives a list of collected questionnaire answer texts as an input. The input data is an array of free-description texts transmitted from participants and a numerical array indicating answers to multiple-choice questions. The number of dimensions of the input data is a variable-length text vector and a fixed-length numerical vector corresponding to the number of respondents. As a specific example, an array of text data regarding useful care cases, an array of text data regarding points for improvement, and a score array of a five-point evaluation are input. The feedback analysis unit supplies the input data to an encoder of a summary generation model. The feedback analysis unit generates text summarizing an overall tendency using a decoder. The output data is structured data including summary text data, an average value of sentiment scores, and classification results for each topic. As a specific example, a summary text character string indicating that satisfaction is generally high, numerical data of an average score of 0.85, and a topic label of strengthening of a nighttime monitoring system are output. The feedback analysis unit renders the output summary text and score as report-format data. The feedback analysis unit automatically distributes the rendered data to terminals of administrators and leaders. By this process, the system realizes information compression by automatic summarization of a large amount of text data. The system dramatically reduces time for administrators to analyze feedback. The system exhibits technical effects of saving storage capacity and reducing a network transfer amount. Furthermore, the feedback analysis unit calculates a cosine similarity between vector representations of the current analysis result and past feedback histories. The feedback analysis unit quantitatively evaluates how the quality of events changes in chronological order. Thereby, the system automatically executes long-term trend analysis for improving care quality of the entire organization, not limited to a single event evaluation.

### Specific Use Case

For example, when targeting nursing care staff who were enrolled in an elderly nursing care facility Y during a period from 2021 to 2022 and user families who entrusted their families to the facility during the same period, first, the nursing care information management unit centrally stores and manages, as a database, staff names, IDs, roles (nursing care staff, nurses, rehabilitation staff, registered dietitians, etc.), affiliated facilities, assignment start dates and end dates, contact information, transfer histories, histories of users in charge, qualification information, evaluation information, training histories, accident/near-miss report histories, care case information, past exchange meeting participation histories, exchange histories on an internal SNS, family meeting participation histories, request/complaint histories from families, user state change records, vital data, medication management histories, meal management histories, rehabilitation plan histories, cooperation histories with external medical institutions, and the like, and similarly records names, IDs, family attributes, admission periods, staff in charge, family meeting participation histories, questionnaire results, request/complaint histories, user state change records, and the like for user families as well. Next, the group generation unit generates prompt sentences using generative AI, such as “Extract staff who were enrolled in facility Y from 2021 to 2022 and group them”, “Extract user families who entrusted their families to facility Y from 2021 to 2022 and group them”, “Group staff who have been in charge of the same user together”, and “Group families who made remarks about nighttime monitoring at a family meeting together”, and automatically extracts and groups the corresponding staff and user families. For the grouped staff, roles, years of experience, qualifications, track records of sharing care cases, evaluations from families, the number of accident/near-miss reports, and the like are comprehensively evaluated, and a prompt sentence “Select an optimal leader from among the grouped staff in consideration of roles, years of experience, qualifications, track records of sharing care cases, and evaluations from families” is read by the generative AI to automatically select an optimal leader. Specifically, in this specific use case, the system executes data extraction and grouping by distributed processing using a plurality of computing nodes. The system receives attribute data of staff and families of facility Y as an input. The input data is a multidimensional vector in which enrollment periods, roles, qualification information, and the like are digitized and categorized. The number of dimensions of the input data is a feature quantity matrix of several hundred dimensions depending on a schema of the database. As a specific example, difference data of timestamps indicating enrollment periods, a one-hot vector indicating a role, and data obtained by vectorizing remark contents at a family meeting are input. The system passes the input data to an input layer of the generative AI, and executes condition determination and similarity calculation based on the prompt sentences. The output data is structured data including a list of grouped nodes and a node identifier of the selected leader. As a specific example, character string data as a group identifier, an identifier array of affiliated members, and a specific user ID as a leader identifier are output. The system associates the output group identifier with the leader identifier and saves them in a predetermined table of the database. The system asynchronously starts a subsequent event notification process triggered by completion of the saving process. By this process, the system speeds up data extraction and group formation based on complex conditions. The system realizes query optimization of a relational database. The system exhibits a technical effect of instantaneously constructing an optimal community matching a specific purpose from an enormous amount of personnel data and nursing care records. Furthermore, the system automatically generates and provides a dashboard screen summarizing characteristics of group members and past exchange histories to the selected leader. Thereby, the system supports prior knowledge for the leader to smoothly manage the group at a hardware level, and dramatically increases the success probability of the event.

The communication support unit automatically generates guidance texts and instruction texts using generative AI, such as “For the grouped staff, a care case sharing meeting among staff who have work experience at facility Y from 2021 to 2022 will be held. Those who wish to participate, please register from the following link”, “For the grouped user families, an exchange meeting among user families who entrusted their families to facility Y during the same period will be held. Those who wish to participate, please contact us”, and “We request the leader to organize the event. We will perform confirmation of attendance of participants, adjustment of agendas, material distribution, progress support by AI, and the like”, and distributes them using e-mail, an internal SNS, a chat tool, a portal site, calendar linkage, smartphone notifications, and the like. The event management unit causes the AI to read prompt sentences such as “Analyze the calendars of all participants and propose a date and time when the largest number of people can participate”, “Automatically generate an event schedule and an agenda list”, and “Issue a link for the online meeting system and distribute it to the participants”, and automates schedule adjustment, venue reservation, online meeting system linkage, material distribution, schedule creation, agenda setting, participant management, minutes creation, recording/audio data management, questionnaire distribution, follow-up after the event, and the like. Specifically, the communication support unit includes a dedicated computing accelerator that executes a transformer-based large language model specialized for natural language processing. The large language model calculates context dependencies of input text using a self-attention mechanism. The communication support unit generates, as input data, a multidimensional feature quantity vector including attribute information of a target person, a past event participation history, and a work or use period at a facility. The feature quantity vector includes, for example, a one-hot encoding vector indicating an occupational category of staff, a continuous value tensor indicating a work period, and a normalized numerical array indicating a remark frequency in past care case sharing meetings. The communication support unit executes tokenization and embedding processing on these input data. The large language model analyzes the input feature quantity vector and outputs text data of a guidance text optimized for the degree of interest and expertise of the target person as a probability distribution. The output data includes, for example, an optimal subject character string for prompting participation, body text explaining the purpose of the event, and a URL character string including a unique identifier for participation registration. The communication support unit parses the output text data and automatically converts it into a format conforming to API specifications of each distribution channel such as e-mail and an internal SNS. The event management unit acquires schedule data of all participants as a time-series array. The event management unit inputs the acquired time-series array into a schedule optimization algorithm. The schedule optimization algorithm expresses free time of each participant as a binary matrix, and specifies a time zone in which free times of all members overlap using a matrix operation. The event management unit scores candidates for the specified time zone, and determines a date and time with the highest score as an event holding date and time. The event management unit calls an API of the online meeting system based on the determined date and time, and automatically generates a virtual room for a meeting. The event management unit directly writes connection information of the generated virtual room into calendar databases of the participants. The large language model receives minutes data of past similar events and text data of related care cases as inputs. The large language model extracts important keywords and topics from the input text data, and outputs an event schedule and an agenda list as structured data. The structured data includes, for example, timestamps indicating a start time and an end time of each agenda, a title character string of the agenda, and an identifier of a person in charge. The event management unit analyzes the output structured data and generates a control script for controlling progress on the day of the event. With this configuration, the system completely eliminates burdens of creating guidance texts and adjusting schedules by human manual work, and dramatically reduces processing time from event planning to distribution. The system exhibits a technical effect of improving a participation rate in an event by generating a guidance text optimized for attributes of a target person. The system instantaneously determines an optimal holding date and time by performing a matrix operation on multidimensional schedule data at high speed, and optimizes utilization efficiency of computing resources. The system provides extremely high practicality in use cases such as information sharing among staff in medical institutions and nursing care facilities, and construction of support networks for user families.

On the day of the event, through the user interface unit, staff and user families perform detailed confirmation of the event, registration of participation availability, preliminary exchange via chat, participation in the online meeting on the day, questionnaire answering, material downloading, FAQ reference, past event history reference, participant list reference, family meeting remark history reference, care case sharing history reference, and the like. During the event, the generative AI executes minutes creation, Q&A by a chatbot, related material presentation, and the like in real time using prompt sentences such as “Summarize remarks during the event as minutes in real time”, “Automatically answer questions from participants by referring to an FAQ database”, and “Present related materials based on past collaboration histories”. Specifically, the user interface unit is implemented as a dedicated application program operating on a client terminal. The user interface unit performs asynchronous communication with a server side, and acquires and displays event-related data in real time. The system acquires audio data generated during the event in a streaming format. The system converts the acquired audio data into an acoustic feature quantity tensor. The system inputs the converted acoustic feature quantity tensor into a convolutional neural network for speech recognition. The convolutional neural network outputs a probability distribution of phonemes from the input acoustic feature quantity tensor, and converts this into text data. The system inputs the converted text data into a large language model as a time-series word vector array. The large language model analyzes a context of the input word vector array, and outputs structured data including summary text of a remark and an identifier of a speaker. The structured data includes, for example, a classification label indicating an intention of a remark, a list of important keywords, and a character string of a summarized sentence. The system writes the output structured data into a database in real time, and distributes it to the user interface unit as dynamic minutes. The system receives question text input from a participant through a chat interface. The system inputs the question text into a natural language processing model, and generates a vector representation indicating an intention of the question. The system calculates a cosine similarity between the generated vector representation and each entry in an FAQ database vectorized in advance. The system specifies an FAQ entry having a similarity exceeding a predetermined threshold, and extracts its answer text. The system automatically replies the extracted answer text to the chat interface. The system searches a past collaboration history database using an identifier of a participant as a key. The system extracts document identifiers of past project materials and care cases related to a current agenda based on a search result. The system accesses a document management server using the extracted document identifiers, and generates a download link for corresponding materials. The system transmits the generated download link to the user interface unit as a push notification. With this configuration, the system exhibits a technical effect of textualizing and summarizing audio data during an event in real time, and making a human recorder unnecessary. The system provides a highly accurate automatic answer even to an ambiguous question that cannot be handled by a conventional keyword search by using similarity calculation in a high-dimensional vector space. The system dynamically presents related materials according to a context of a participant, thereby reducing time required for information retrieval and facilitating progress of an event. The system integrates an online meeting system and advanced natural language processing technology, thereby providing an information sharing experience equal to or better than face-to-face even to staff and families participating from remote locations.

After the event ends, the feedback analysis unit causes the generative AI to read prompt sentences such as “Extract satisfaction, points for improvement, and new ideas from feedback of event participants and summarize them as a report” and “Analyze characteristics of this event in comparison with past feedback histories”, automatically analyzes feedback collected from participants, and automatically distributes satisfaction evaluations, extraction of points for improvement, proposals for new care methods and family support measures, proposals for the next event, and the like to administrators and leaders as a report. In this way, knowledge sharing among staff and families, network construction, business improvement at sites, service quality improvement, fostering of a sense of security for families, staff motivation improvement, care quality improvement for users, and the like can be efficiently and sustainably realized. Specifically, the feedback analysis unit collects questionnaire answer data transmitted from participant terminals after the event ends. The questionnaire answer data includes free-description text data and multiple-choice numerical data. The feedback analysis unit performs morphological analysis on the collected text data, and generates a feature quantity matrix indicating appearance frequencies and dependency relationships of words. The feedback analysis unit inputs the generated feature quantity matrix into a recurrent neural network for sentiment analysis. The recurrent neural network has learned time-series dependencies of the input feature quantity matrix, and outputs a positive or negative sentiment score for each text data. The feedback analysis unit integrates the output sentiment scores and numerical data, and calculates a comprehensive evaluation score indicating satisfaction of participants. The feedback analysis unit inputs the free-description text into a topic modeling algorithm. The topic modeling algorithm outputs a probability distribution of latent topics from a text group. The feedback analysis unit classifies the text data into a cluster regarding points for improvement and a cluster regarding new ideas based on the output probability distribution. The feedback analysis unit extracts representative keywords of each classified cluster, and inputs them into a large language model. The large language model comparatively analyzes the input keyword group and history data of past event reports. The large language model outputs analysis text indicating a tendency peculiar to this event and changes from past events. The analysis text includes, for example, sentences indicating an increased interest in a specific care method, sentences pointing out operational issues, and a list of recommended themes to be taken up in the next event. The feedback analysis unit integrates the calculated comprehensive evaluation score, the classified cluster information, and the output analysis text, and generates structured report data. The feedback analysis unit converts the generated report data into a document in an HTML format or a PDF format. The feedback analysis unit automatically transmits the converted document to terminals of administrators and leaders. With this configuration, the system exhibits a technical effect of analyzing a large amount of unstructured text data at high speed using vector operations and probability models peculiar to computers, and overcoming limits of aggregation and analysis by human manual work. The system extracts latent issues and useful ideas that cannot be discovered by a superficial keyword search with high accuracy by combining sentiment analysis and topic modeling. The system supports accumulation of organizational knowledge and continuous business improvement by automating comparison with past history data. The system provides a data-driven decision-making foundation directly linked to improvement of service quality by formalizing tacit knowledge of staff in medical and nursing care sites.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

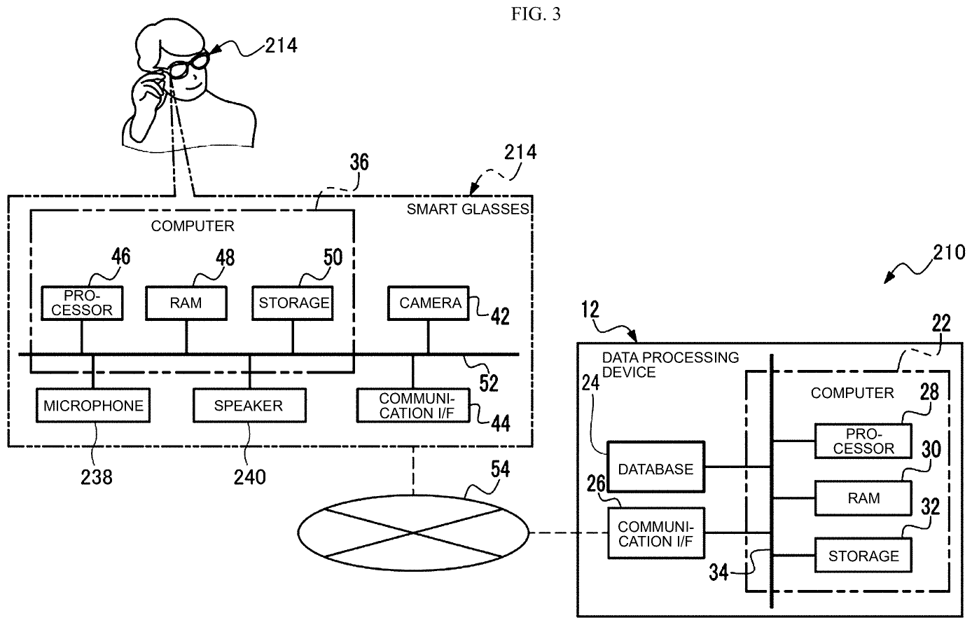

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

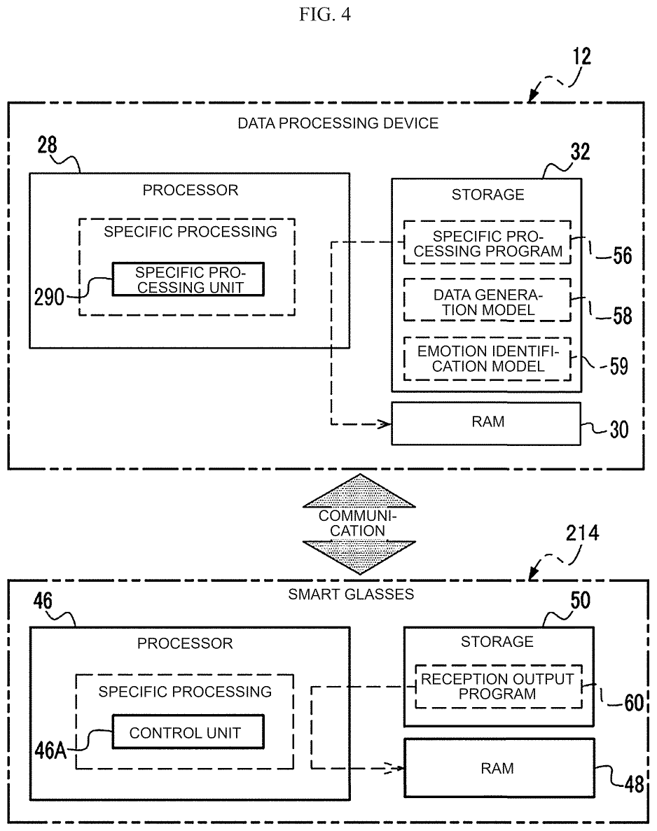

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

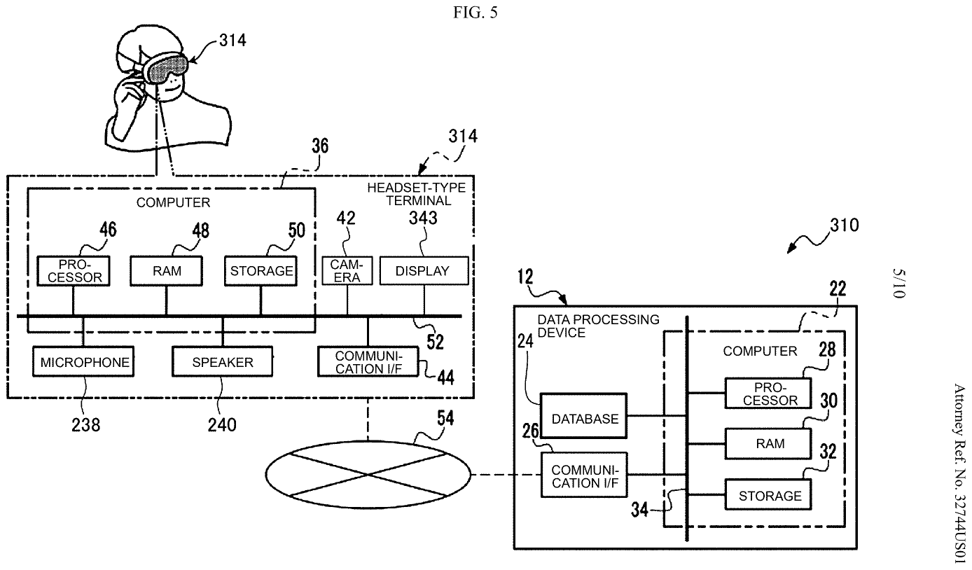

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

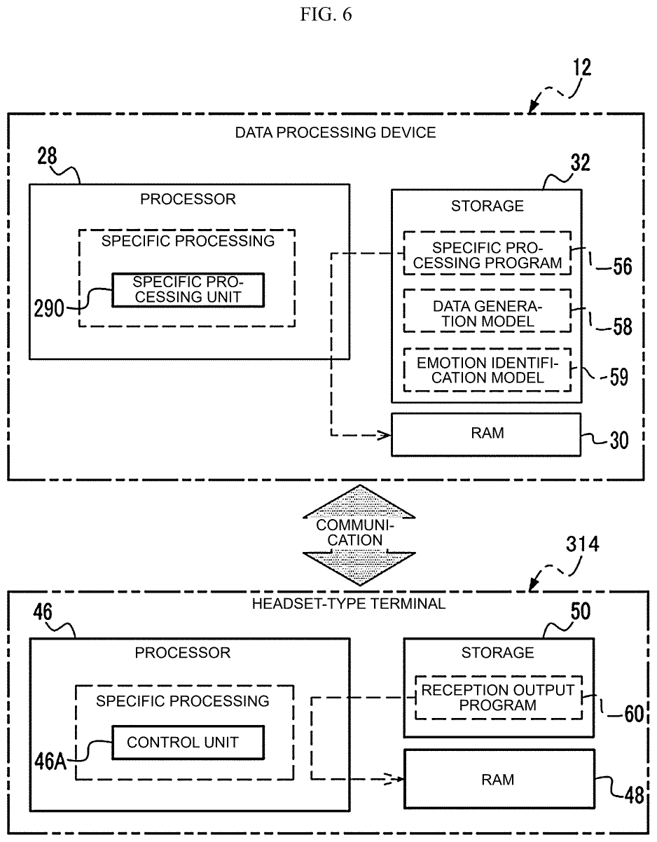

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

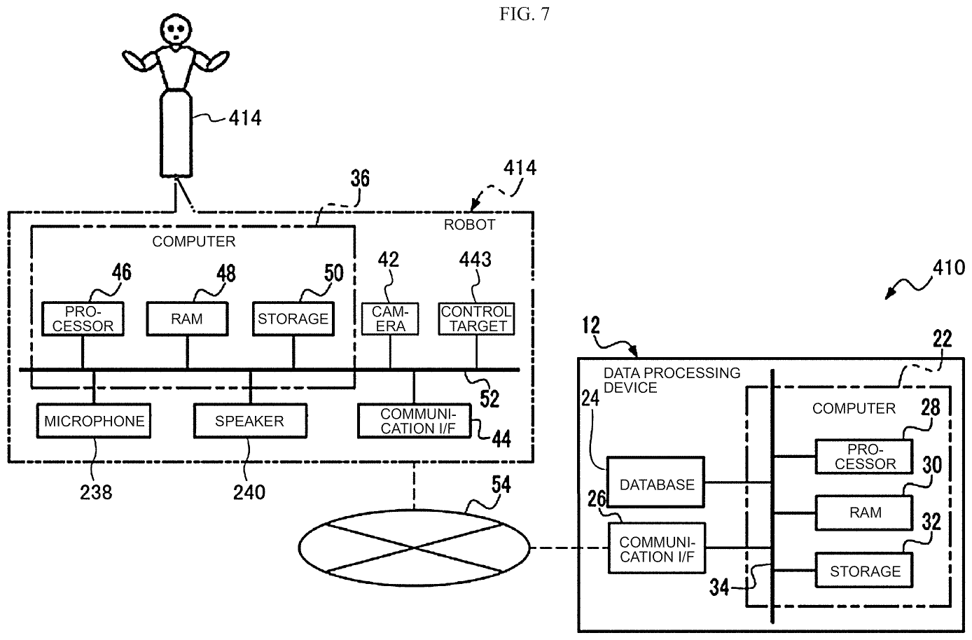

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

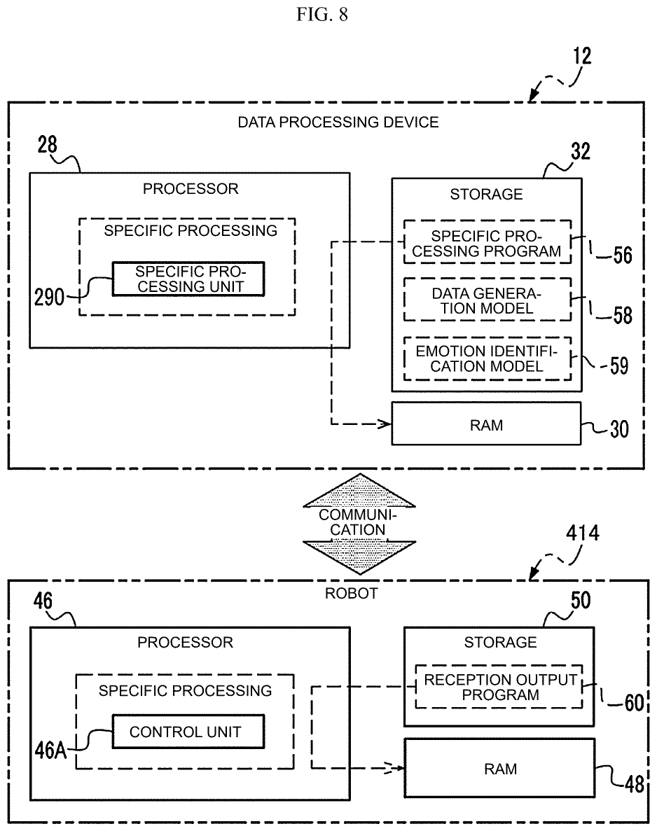

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

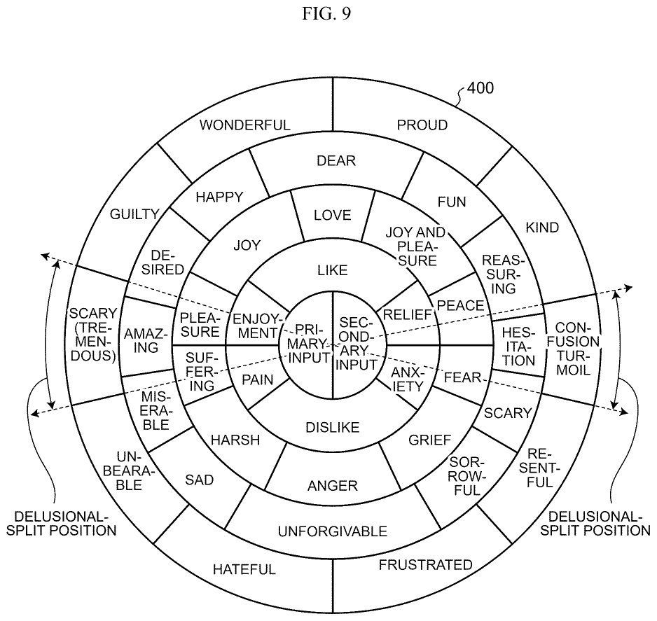

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

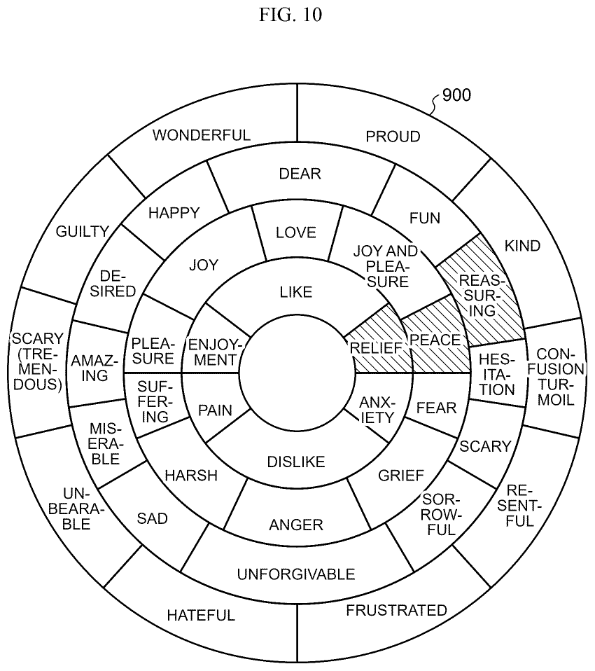

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A system comprising: a nursing care information management unit; a group generation unit; and a communication support unit, wherein the nursing care information management unit centrally stores and manages, as a database, nursing care-related information such as names, roles, affiliated facilities, assignment start dates and end dates, contact information, transfer histories, histories of users in charge, past exchange meeting participation histories, care case information, qualification information, evaluation information, and questionnaire results of staff and user families involved in nursing care facilities or home nursing care services; the group generation unit analyzes the information stored in the nursing care information management unit using generative AI, automatically extracts staff members or user families who were involved together in a specified facility during a specified period, groups the corresponding persons, and automatically selects a leader from within the group in consideration of roles, years of experience, qualifications, past leader experiences, and the like; and the communication support unit automatically transmits, using generative AI, notifications of holding information sharing meetings and exchange meetings, participation requests, instructions for organizing the events to the leader, guidance on sharing care know-how, and guidance on using an online meeting system to the grouped staff or user families and the leader using e-mail, an internal SNS, a chat tool, a portal site, or the like, and further collects feedback from participants after the events end to reflect the feedback in subsequent events and business improvements at nursing care sites.

### Supplementary Note 2

The system according to Supplementary Note 1, including a process of: automatically setting, using generative AI, a person having the longest enrollment period, a qualification holder, a person who played a central role in past exchange meetings, or a person having a large track record of sharing care cases as the leader when no leader exists among the staff or user families grouped by the group generation unit; and transmitting, by the communication support unit, a notification requesting the leader to organize the event.

### Supplementary Note 3

The system according to Supplementary Note 1, including a process in which the communication support unit automatically collects, using generative AI, feedback regarding care cases, exchange contents, future requests, points for improvement, and new ideas from the participants after the event ends, analyzes the collected feedback, and utilizes the analyzed feedback for theme setting of subsequent information sharing meetings and exchange meetings, group configurations, business improvements at nursing care sites, optimization of staff education programs, proposals of support measures for user families, and the like.

What is claimed is:

1. A system comprising:
circuitry configured to:
receive, via a communication interface coupled to a packet-switched network, entity attribute records comprising temporal interval parameters, grouping context identifiers, and attribute classification parameters for a plurality of entities, and store the entity attribute records in a storage device;
apply a temporal interval intersection algorithm to the temporal interval parameters and grouping context identifiers stored in the storage device to identify sets of entity attribute records having overlapping temporal intervals within matching grouping context identifiers, and generate co-interval group data structures associating overlapping entity identifiers;
apply a generative neural network model to the co-interval group data structures and the attribute classification parameters to select a primary entity identifier from among the overlapping entity identifiers based on attribute classification parameters and interval duration metrics;
generate output message data for each co-interval group data structure by applying the generative neural network model to group parameters and context data retrieved from a vector database storing historical interaction records; and
transmit the output message data to terminal devices associated with overlapping entity identifiers via the communication interface.

2. The system according to claim 1, wherein the circuitry is configured to receive streaming sensor data from IoT monitoring devices via the communication interface, apply initial feature extraction and anomaly detection processing to the streaming sensor data at an edge computing node, and transmit preprocessed feature vectors to a cloud computing node for integration with the entity attribute records in the storage device.

3. The system according to claim 2, wherein the circuitry is configured to integrate the preprocessed feature vectors with entity attribute records in the storage device by mapping sensor device identifiers to corresponding entity identifiers, store integrated records in a time-series data structure, and update the entity attribute records with aggregated sensor-derived state parameters at configurable intervals.

4. The system according to claim 1, wherein the circuitry is configured to query a plurality of external data source systems via API integration using the communication interface to retrieve updated attribute fields associated with entity identifiers, and merge the retrieved attribute fields into the entity attribute records in the storage device using the entity identifier as a join key.

5. The system according to claim 1, wherein the circuitry is configured to compute an interval duration metric for each entity identifier within a co-interval group data structure by calculating a duration value from the temporal interval parameters, and apply the generative neural network model to rank overlapping entity identifiers in descending order of interval duration metric when no entity identifier in the co-interval group data structure is associated with a primary attribute classification parameter.

6. The system according to claim 1, wherein the circuitry is configured to generate the output message data by constructing a prompt comprising group parameters, historical interaction records retrieved from the vector database, and a message type parameter, and generating message text by autoregressive decoding conditioned on the prompt.

7. The system according to claim 6, wherein the circuitry is configured to transmit primary entity-specific output message data comprising task instruction sequences to the terminal device associated with the primary entity identifier, and transmit participant-specific output message data comprising event detail parameters and eligibility parameters to terminal devices associated with non-primary overlapping entity identifiers.

8. The system according to claim 1, wherein the circuitry is configured to receive response data from terminal devices via the communication interface indicating participation status for each notified entity identifier, store the response data as participation records in the storage device, and update the co-interval group data structure with an attendance parameter derived from the participation records.

9. The system according to claim 1, wherein the circuitry is configured to receive feedback data records from terminal devices following a group interaction event via the communication interface, apply the generative neural network model to the feedback data records to extract sentiment polarity scores, key phrase embeddings, and topic classification labels, and store the sentiment polarity scores and topic classification labels in the storage device as interaction outcome records.

10. The system according to claim 9, wherein the circuitry is configured to aggregate topic classification labels and sentiment polarity scores from interaction outcome records across a plurality of co-interval group data structures, generate a trend analysis vector representing recurring themes and sentiment trajectories, and incorporate the trend analysis vector as context data in the vector database for subsequent output message data generation.

11. The system according to claim 9, wherein the circuitry is configured to apply the generative neural network model to the interaction outcome records and historical interaction records retrieved from the vector database to generate an improvement recommendation data record for subsequent group interaction events, and store the improvement recommendation data record in the storage device.

12. The system according to claim 1, wherein the circuitry is configured to generate co-interval group data structures for a plurality of distinct temporal intervals and grouping context identifier combinations, and deduplicate overlapping entity identifier sets across co-interval group data structures using a hash-based set intersection algorithm.

13. The system according to claim 12, wherein the circuitry is configured to compute a co-interval frequency metric for each pair of entity identifiers appearing together across multiple co-interval group data structures, and weight the output message data generation prompt with the co-interval frequency metric to prioritize high-frequency co-interval pairs in message content.

14. The system according to claim 1, wherein the circuitry is configured to execute a lightweight inference model on a terminal device to perform initial classification of incoming response data, generate a compressed response vector, and transmit the compressed response vector to the cloud computing node via the communication interface to reduce data transfer volume.

15. The system according to claim 1, wherein the circuitry is configured to apply a natural language processing model to entity attribute records comprising qualification records and training history records to generate a competency embedding vector for each entity identifier, and incorporate competency embedding vectors as additional node attributes in the co-interval group data structures.

16. The system according to claim 1, wherein the circuitry is configured to update the generative neural network model used for output message data generation by generating training pairs from historical output message data records and corresponding interaction outcome records, and fine-tune the generative neural network model on the training pairs to improve message relevance scores.

17. The system according to claim 1, wherein the temporal interval parameters comprise start timestamps and end timestamps for each grouping context identifier, the co-interval group data structures identify entities having overlapping temporal intervals exceeding a minimum co-interval duration threshold, and the primary entity identifier is associated with the entity having the highest attribute classification rank or longest interval duration within the group.

18. A system comprising:
circuitry configured to:
receive, via a communication interface coupled to a packet-switched network, entity attribute records comprising temporal interval parameters, grouping context identifiers, and attribute classification parameters;
apply a temporal interval intersection algorithm to identify co-interval group data structures associating entity identifiers having overlapping temporal intervals within matching grouping context identifiers;
apply a generative neural network model to select a primary entity identifier and generate output message data by autoregressive decoding conditioned on group parameters and context data retrieved from a vector database;
receive feedback data records and extract sentiment polarity scores and topic classification labels for incorporation as updated context data; and
transmit output message data to terminal devices and store interaction outcome records in the storage device.

19. The system according to claim 18, wherein the circuitry is configured to aggregate topic classification labels and sentiment polarity scores from interaction outcome records across co-interval group data structures to generate a trend analysis vector, and incorporate the trend analysis vector as updated context data in the vector database for subsequent output message data generation.

20. A method comprising:
receiving, via a communication interface coupled to a packet-switched network, entity attribute records comprising temporal interval parameters, grouping context identifiers, and attribute classification parameters for a plurality of entities, and storing the entity attribute records in a storage device;
applying a temporal interval intersection algorithm to identify sets of entity attribute records having overlapping temporal intervals within matching grouping context identifiers, and generating co-interval group data structures associating overlapping entity identifiers;
applying a generative neural network model to the co-interval group data structures and the attribute classification parameters to select a primary entity identifier based on attribute classification parameters and interval duration metrics;
generating output message data for each co-interval group data structure by applying the generative neural network model to group parameters and context data retrieved from a vector database; and
transmitting the output message data to terminal devices associated with overlapping entity identifiers via the communication interface.
